(19) United States
(12) Patent Application Publication
(10) Pub. No.: US 2026/0035209 A1
(43) Pub. Date: Feb. 5, 2026

(54) ELEVATOR CABLE MANAGEMENT SYSTEM

(71) Applicant: Power Climber B.V., Kontich (BE)

(72) Inventors: Nicolas VAN DER LINDEN, Lint (BE); Koen PALLET, Niel (BE); Dirk MISEUR, Wolvertem (BE)

(73) Assignee: Power Climber B.V., Kontich (BE)

(21) Appl. No.: 19/288,460

(22) Filed: Aug. 1, 2025

Related U.S. Application Data
(60) Provisional application No. 63/678,873, filed on Aug. 2, 2024.

(51) Int. Cl. B66B 7/08

(52) U.S. Cl. CPC B66B 7/08

(57) ABSTRACT

An elevator cable management system includes a gate hingedly coupled with a first body, where the gate is configured to retain one or more cables that extend from an elevator car when in a closed position, where the gate is configured to transition from the closed position to an open position responsive to the elevator car making contact with the elevator cable management system, and where the first body is configured to rotate away from the one or more cables to a position aside the elevator car responsive to the elevator car moving relative to the elevator cable management system.

### CROSS-REFERENCE TO RELATED APPLICATION

This application claims the benefit of and priority to U.S. Provisional Application No. 63/678,873, filed Aug. 2, 2024, which is hereby incorporated herein by reference in its entirety and for all purposes.

### BACKGROUND

The present disclosure relates generally to the field of elevators that can move people or cargo vertically with respect to a structure. In one aspect, the present disclosure relates to an elevator cable management system.

Elevators move people and objects vertically along a track, for example, between floors or platforms of a building or other structure. Traction elevators are suspended and moved on traction cables, wires, or ropes driven by a motor. The traction cables, wires, or ropes may, for example, be steel ropes which are pulled over a grooved pulley system called a sheave or may be flat belts made of steel or polyethylene. One or more guide rails or cables may define the track that an elevator car moves along between the upper terminus and the lower terminus of the track.

### SUMMARY

One embodiment of the present disclosure relates to an elevator cable management system. The elevator cable management system includes a first body and a gate hingedly coupled with the first body. The gate can be configured to retain one or more first cables that extend from an elevator car when in a closed position. The gate can transition from the closed position to an open position responsive to the elevator car making contact with the elevator cable management system. The elevator cable management system can move away from the one or more first cables to a position aside the elevator car responsive to the elevator car moving relative to the elevator cable management system.

Another embodiment of the present disclosure relates to an elevator system that includes an elevator car, one or more cables that extend through the elevator car, and an elevator cable management system. The elevator cable management system includes an outer body and an inner body and a gate hingedly coupled with a first side of the outer body and a second side of the outer body. The gate retains the one or more cables that extend from the elevator car when in a closed position. The gate can transition from the closed position to an open position responsive to the elevator car making contact with the inner body. The elevator cable management system can rotate away from the one or more cables to a position aside the elevator car responsive to the elevator car moving relative to the elevator cable management system.

Another embodiment of the present disclosure relates to an elevator cable management system including a first arm having a first end and a second end, a second arm having a third end and a fourth end, an interface coupled with the first end of the first arm, and a retaining mechanism coupled with the fourth end of the second arm, the retaining mechanism configured to retain one or more cables that extend from an elevator car. The first arm and the second arm can be coupled at the second end and the third end. Responsive to the elevator car making contact with the interface, the second arm is configured to rotate about the third end causing the one or more cables to pass through the retaining mechanism as the second arm rotates.

Another embodiment of the present disclosure relates to an elevator cable management system that includes a mount, a first arm, a second arm, a gate, and a stop. The first arm is pivotably coupled to the mount and configured to rotate relative to the mount between an extended position and a retracted position. The second arm is pivotably coupled to the first arm and configured to rotate relative to the first arm between a disengaged position and an engaged position. The gate can move between an open position and closed position to enclose one or more cables of an elevator system within the first arm. The stop can limit rotation of the first arm and stop the first arm in the extended position. In operation, the second arm contacts an elevator moving upward through an elevator shaft, thereby causing the second arm to rotate from the disengaged position to the engaged position. In operation, rotation of the second arm to the engaged position opens the gate allowing the one or more cables to exit the first arm. In operation, the first arm or the second arm is configured to contact the elevator moving upward through the elevator shaft, thereby causing the first arm to rotate from extended position to the retracted position.

Another embodiment of the present disclosure relates to a method of operating an elevator cable management system. The method includes moving an elevator upward within an elevator shaft along one or more cables, enclosing the one or more cables within an arm when the elevator is located below the arm, and opening a gate in response to the arm contacting the elevator as the elevator moves upward within the elevator shaft. The method further includes moving the arm from an extended position to a retracted position in response to the arm contacting the elevator, thereby allowing the one or more cables to exit the arm and allowing the elevator to move upward past the arm. The method includes holding the arm in the retracted position with the one or more cables or an internal mechanism.

This summary is illustrative only and is not intended to be in any way limiting. Other aspects, inventive features, and advantages of the devices or processes described herein will become apparent based on the detailed description set forth herein, taken in conjunction with the accompanying drawings.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is an exploded view of an elevator cable management system, according to a first embodiment.

FIG. 2 is a perspective view of an arm of the elevator cable management system in an extended position with gates in a closed position, according to the first embodiment.

FIG. 3 is a sequential perspective view of the arm of the elevator cable management system in an extended position while in contact with a top surface of an elevator traveling upwards, according to the first embodiment.

FIG. 4 is a sequential perspective view of the arm of the elevator cable management system tilted and in contact with the top surface of the elevator, according to the first embodiment.

FIG. 5 is another sequential perspective view of the arm of the elevator cable management system tilted and in contact with the top surface of the elevator, according to the first embodiment.

FIG. 6 is a sequential perspective view of the arm of the elevator cable management system in a retracted position and in contact with a surface of the elevator, according to the first embodiment.

FIG. 7 is a sequential perspective view of the arm of the elevator cable management system in the retracted position and approaching a retainer bracket holding one or more cables, the retainer bracket and cables being positioned on the surface of the elevator, according to the first embodiment.

FIG. 8 is a sequential perspective view of the arm of the elevator cable management system in the retracted position and interfacing with the retainer bracket, according to the first embodiment.

FIG. 9 is a sequential perspective view of the arm of the elevator cable management system in the retracted position and approaching cables extending from the retainer bracket, according to the first embodiment.

FIG. 10 is a sequential perspective view of the arm of the elevator cable management system in the retracted position and resting on cables, according to the first embodiment.

FIG. 11 is another sequential perspective view of the arm of the elevator cable management system in the retracted position and resting on cables, according to the first embodiment.

FIG. 12 is another sequential perspective view of the arm of the elevator cable management system in the retracted position and resting on cables, according to the first embodiment.

FIG. 13 is a sequential perspective view of the arm of the elevator cable management system in the retracted position and approaching the retainer bracket while the elevator travels downwards, according to the first embodiment.

FIG. 14 is a sequential perspective view of the arm of the elevator cable management system in the retracted position while in contact with the retainer bracket, according to the first embodiment.

FIG. 15 is a sequential perspective view of the arm of the elevator cable management system in the retracted position and in contact with the surface of the elevator, according to the first embodiment.

FIG. 16 is another sequential perspective view of the arm of the elevator cable management system in the retracted position and in contact with the back surface of the elevator, according to the first embodiment.

FIG. 17 is a sequential perspective view of the arm of the elevator cable management system tilted and in contact with the top surface of the elevator, according to the first embodiment.

FIG. 18 is another sequential perspective view of the arm of the elevator cable management system tilted and in contact with the top surface of the elevator, according to the first embodiment.

FIG. 19 is a sequential perspective view of the arm of the elevator cable management system in the extended position with the gate in an open position, according to the first embodiment.

FIG. 20 is a sequential perspective view of the arm of the elevator cable management system in the extended position with the gate in a closed position, according to the first embodiment.

FIG. 21 is a perspective view of an arm of an elevator cable management system in an extended position, according to a second embodiment.

FIG. 22 is a sequential perspective view of the arm of the elevator cable management system in the extended position and with gates partially open due to contact with a top surface of an elevator while the elevator travels upwards, according to the second embodiment.

FIG. 23 is a sequential perspective view of the arm of the elevator cable management system tilted and with the gate in an open position, according to the second embodiment.

FIG. 24 is a sequential perspective view of the arm of the elevator cable management system while being further tilted upwards by the top surface of the elevator, according to the second embodiment.

FIG. 25 is a sequential perspective view of the arm of the elevator cable management system in a retracted position and in contact with a surface of the elevator, according to the second embodiment.

FIG. 26 is a sequential perspective view of the arm of the elevator cable management system in the retracted position and approaching a retainer bracket positioned on the surface of the elevator, according to the second embodiment.

FIG. 27 is a sequential perspective view of the arm of the elevator cable management system in the retracted position and resting on cables extending from the retainer bracket, according to the second embodiment.

FIG. 28 is a sequential perspective view of the arm of the elevator cable management system in the retracted position and in contact with the retainer bracket while the elevator travels downwards, according to the second embodiment.

FIG. 29 is a sequential perspective view of the arm of the elevator cable management system substantially vertical and in contact with a surface of the elevator, according to the second embodiment.

FIG. 30 is a sequential perspective view of the arm of the elevator cable management system tilted and in contact with the top surface of the elevator, according to the second embodiment.

FIG. 31 is a sequential perspective view of the arm of the elevator cable management system tilted and with the gate opened, according to the second embodiment.

FIG. 32 is a sequential perspective view of the arm of the elevator cable management system in an extended position and with the gate partially closed, according to the second embodiment.

FIG. 33 is a perspective view of an elevator cable management system, according to a third embodiment.

FIG. 34 is a sequential perspective view of the elevator cable management system with an arm being tilted upward, according to the third embodiment.

FIG. 35 is a sequential perspective view of the elevator cable management system with the arm positioned substantially vertical, according to the third embodiment.

FIG. 36 is a sequential perspective view of the elevator cable management system with the arm being tilted back downward, according to the third embodiment.

FIG. 37 is a perspective view of an elevator cable management system with gates in a closed position, according to a fourth embodiment.

FIG. 38 is a perspective view of the elevator cable management system with gates in an open position, according to the fourth embodiment.

FIG. 39 is a flow chart of a method for operating an elevator cable management system, according to an exemplary embodiment.

### DETAILED DESCRIPTION

Following below are more detailed descriptions of various concepts related to and implementations of methods, apparatuses, and systems related to the embodiments introduced above. The illustrative embodiments described herein are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, and designed in a wide variety of different configurations, all of which are explicitly contemplated and made part of this disclosure.

An elevator cable management system helps to manage the long runs of cables in an elevator shaft. In cases where an elevator shaft may move or bend, such as when the overall building or structure, that the elevator is a part of, may sway or bend as a result of wind pressure on the side of a building, retaining the elevator cables in a safe position within the elevator shaft can be important to prevent damage to the cables or damage to any objects, including other cables, that a swaying cable might contact if not retained. An example application is a service elevator for a large wind turbine or tall construction crane.

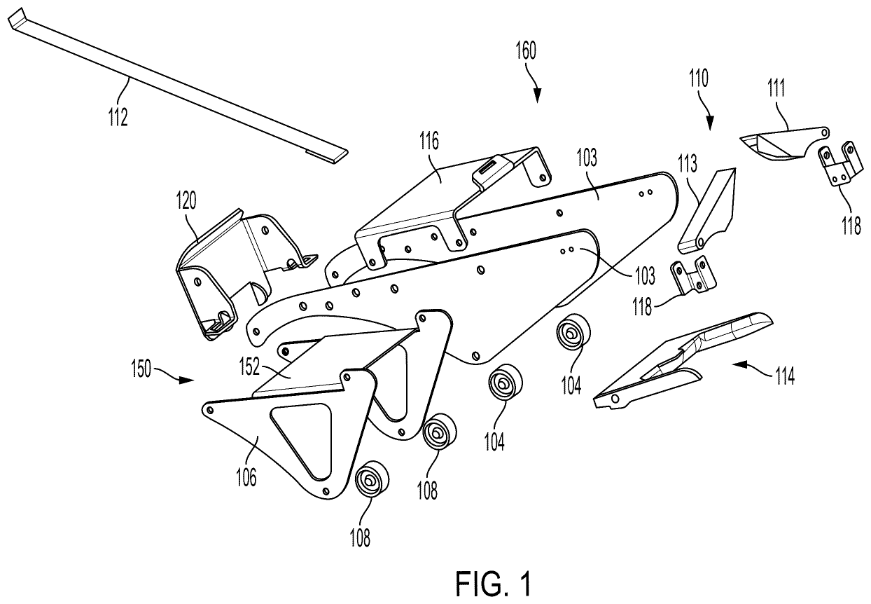

Referring to FIG. 1, an exploded view of an elevator cable management system 100 is shown, according to exemplary embodiments. The elevator cable management system 100 is shown to include an inner body 150 (e.g., a first arm, an inner arm, a first body, etc.) and an outer body 160 (e.g., a second arm, an outer arm, an outer body, etc.).

The inner body 150 includes legs 106 coupled with an inner top plate 152. The legs 106 are coupled with an actuator 114 and with one or more internal rollers 108. As shown, the actuator 114 includes one or more fingers that extend away from the inner top plate 152. In some embodiments, the legs 106, inner top plate 152, and the actuator 114 are constructed as a unitary member. In exemplary embodiments, the legs 106 are relatively triangular. In this example, the legs 106 are coupled with the actuator 114 at an end of the hypotenuse side, or long side, of the triangular legs 106. In this example, the legs 106 are also coupled with the internal rollers 108 at an apex of the triangular legs 106. More particularly, the internal rollers 108 are rotatably coupled to the legs 106 at the apex.

The outer body 160 includes a top plate 116 coupled with side pieces 103. The side pieces 103 extend past a first end and a second end of the top plate 116. The outer body 160 includes a gate 110 positioned perpendicularly to the side pieces 103. The gate 110 includes one or more arms, shown as two arms 111 and 113 that meet at a center point between the two side pieces 103. In some embodiments, the gate 110 is a single arm that extends from one side piece 103 to the other side piece 103. The gate 110 is hingedly coupled with the side pieces 103 via hinges 118 at a front end of the side pieces 103 (e.g., the end closest to an elevator car 10). In this way, the gate 110 is configured to rotate outward about the side pieces 103. The side pieces 103 are pivotably coupled with a mount 120 at an end opposite the gate 110.

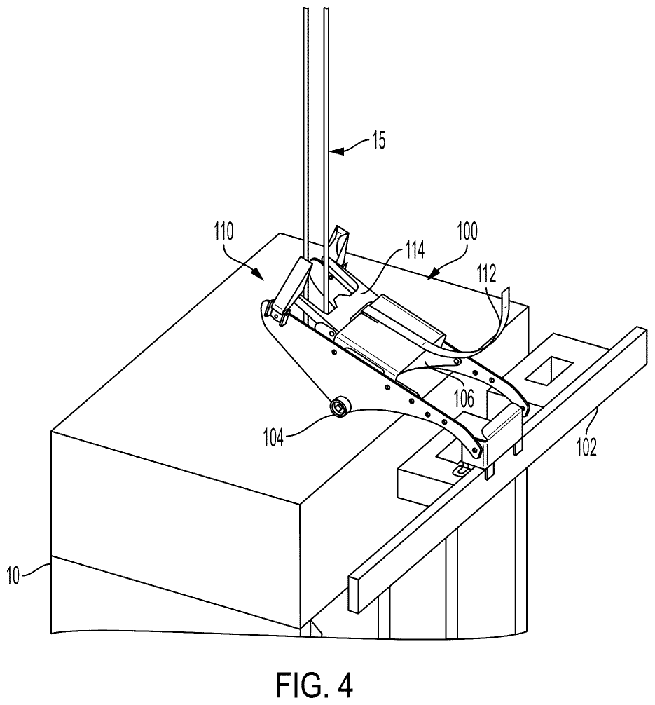

The inner body 150 is pivotably coupled with the outer body 160 at an end of the legs 106 opposite the gate 110. In some embodiments, an inner side of the side pieces 103 includes a stopper that limits the rotational movement of the inner body 150 relative to the outer body 160. In other embodiments, the gate 110 defines a housing that receives the fingers of the actuator 114. The first arm or inner body 150 and second arm or outer body 160 rotate as one arm relative to the mount 120. This concept will be explored in greater detail with respect to FIGS. 4-6.

In some embodiments, a stop 112 is coupled with the top plate 116 at one end and a surface (e.g., a wall, a gallery, a platform, or anything of the like) at the other end. In some examples, the stop 112 is a fabric strap that is coupled with the wall of the elevator shaft at one end and the top plate 116 at the other end. Although a fabric strap is shown, it will be appreciated that the stop 112 can be any suitable style of stop to limit movement of the outer body 160 and the inner body 150 relative to the mount 120 and position the arm in an extended position (e.g., fixed stoppers, bushings, bumpers, brackets, etc.). In some examples, the stop 112 is a mechanism coupled with the outer body (e.g., torsion springs, hinges, detent mechanisms, cam locks, pin locks, etc.). By way of example, the mount 120 may include a spring-loaded hinge that limits the axis of rotation of the elevator cable management system 100 between a substantially vertical position (e.g., parallel with the wall, elevator, or cables) and a substantially horizontal position (e.g., perpendicular to the wall, elevator, or cables).

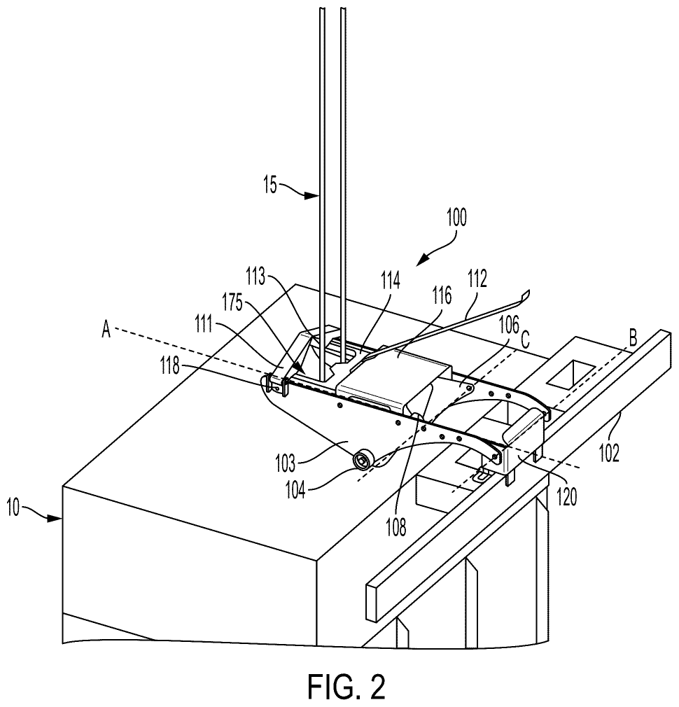

Referring to FIG. 2, a perspective view of an elevator cable management system 100 in an extended position is shown, according to exemplary embodiments. In FIG. 2, an elevator car 10 or cabin moves vertically along a track (not depicted) between stations or stops along the track. At the stops users may leave or enter the elevator car 10 or cargo may be added or removed from the elevator car 10. The elevator cable management system 100 is coupled with a support 102 via the mount 120. The mount 120 affixes the elevator cable management system 100 to a structure, such as a wall, gallery, or platform of the elevator shaft. The elevator cable management system 100 may be mounted at any height in the elevator shaft that is above the elevator car 10 when the elevator car 10 is at ground level.

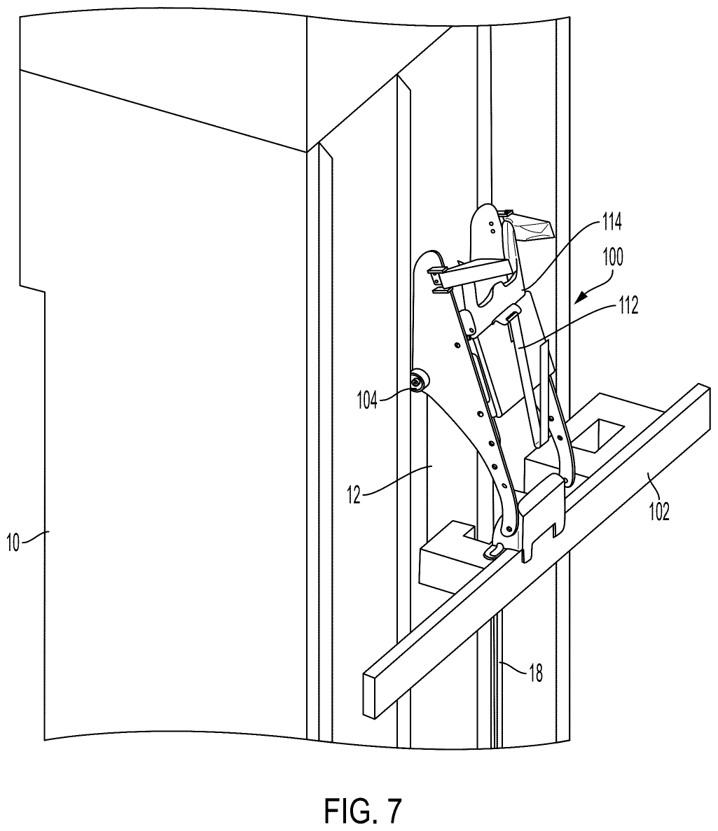

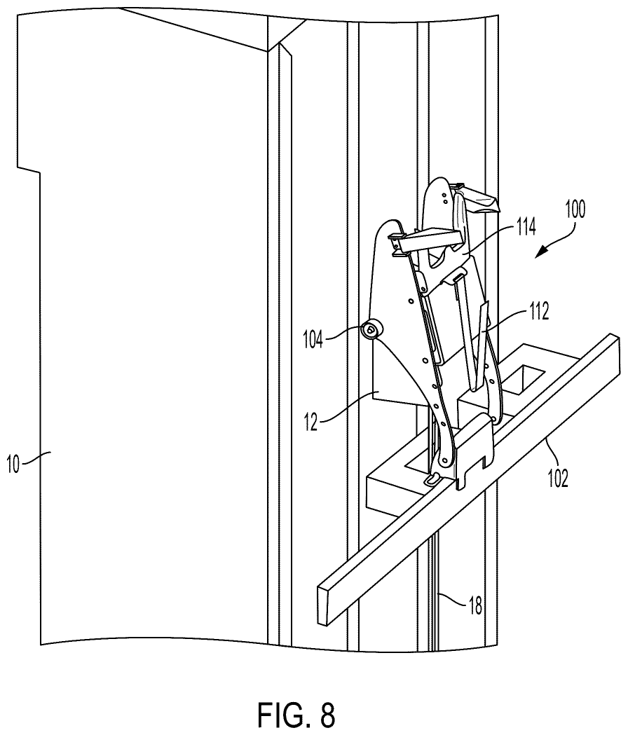

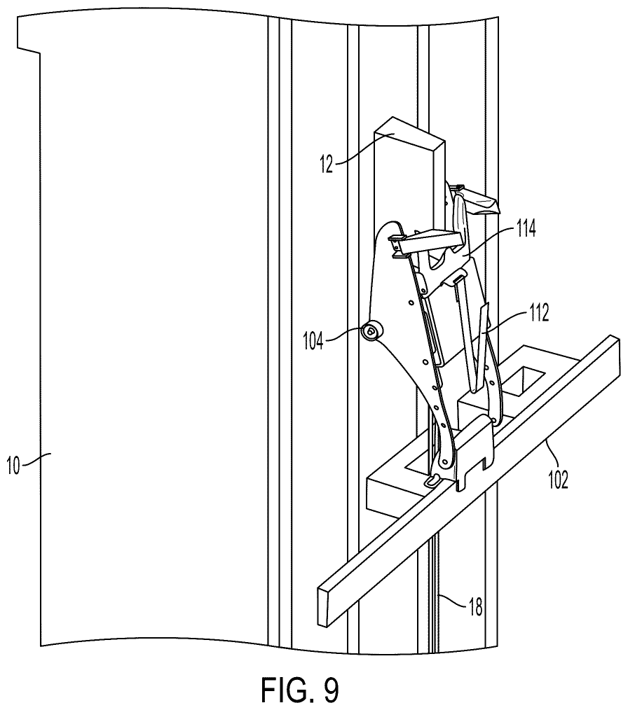

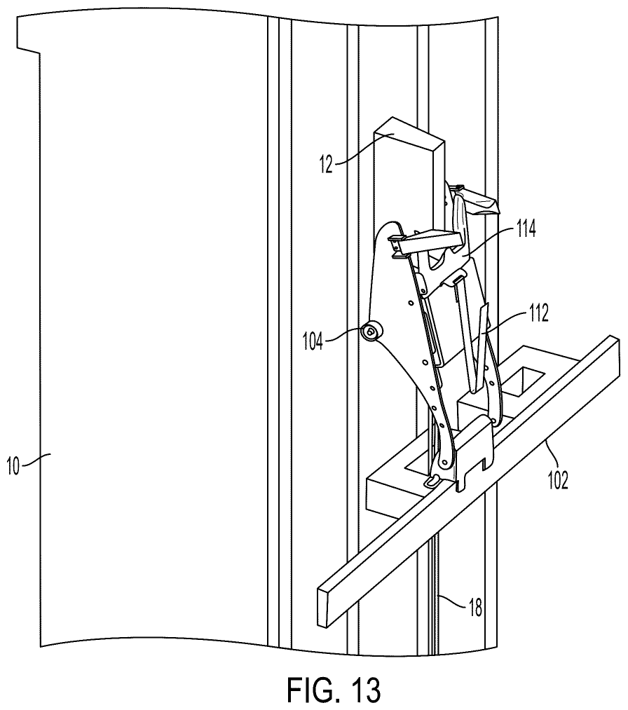

The outer body 160 functions to rotate the inner body 150 and the outer body 160 about the mount 120 (e.g., about axis (B)) into a retracted position responsive to movement by an elevator car 10 upwards through an elevator shaft. The outer body 160 additionally functions to rotate the arm into an extended position responsive to the elevator car 10 moving downwards through the elevator shaft. The stop 112 holds the elevator cable management system 100 in an extended position when the elevator cable management system is not in contact with the elevator car 10 or its associated cables 15. As referred to herein, “extended position” means positioned such that the cables are retained at a predetermined location within the gate 110, the side pieces 103, and the top plate 116. By way of example, the extended position depicted in FIG. 2 is a position that is substantially horizontal (e.g., perpendicular to the wall of the elevator shaft). One or more cables 15 extend from a top portion of the elevator car 10. The cables 15 are fed through a top portion of the elevator car 10 and exit through a side portion of the elevator car 10 (as shown in FIGS. 7-13). The cables 15 run the entire height of the elevator shaft (e.g., from the top of the elevator shaft to the bottom of the elevator shaft). In the exemplary embodiments, the cables 15 are hoisting cables that provide the force to raise and lower the elevator car 10. In exemplary embodiments, the cables 15 are steel wire ropes; however, the cables 15 may be made of any suitable material. As the elevator car 10 moves upward through the elevator shaft, the elevator car 10 travels along the cables with the cables passing through the top of the elevator car 10 and exiting through the side of the elevator car 10, such that the trailing portion of the cables is offset from the leading portion of the cables (i.e., there is a horizontal separation between the portion of the cables above the elevator car 10 and the portion of the cables below the elevator car 10).

The side pieces 103 extend past the top plate 116, and the gate 110 is coupled with an end of each of the side pieces furthest from the support 102. In this way, the top plate 116, side pieces 103, and gate 110 form an opening 175 through which cables are retained (e.g., enclosed, surrounded, confined). In exemplary embodiments, the components of the outer body 160 are positioned such that there is space between the cables 15 and the surrounding side pieces 103, and the top plate 116 (i.e., defined by the opening 175). In this way, the cables 15 may occasionally come into contact with the elevator cable management system 100 when swaying, but are prevented from coming into contact with other components of the elevator system, such as the elevator shaft, platforms, gallery, or other cables, among other components.

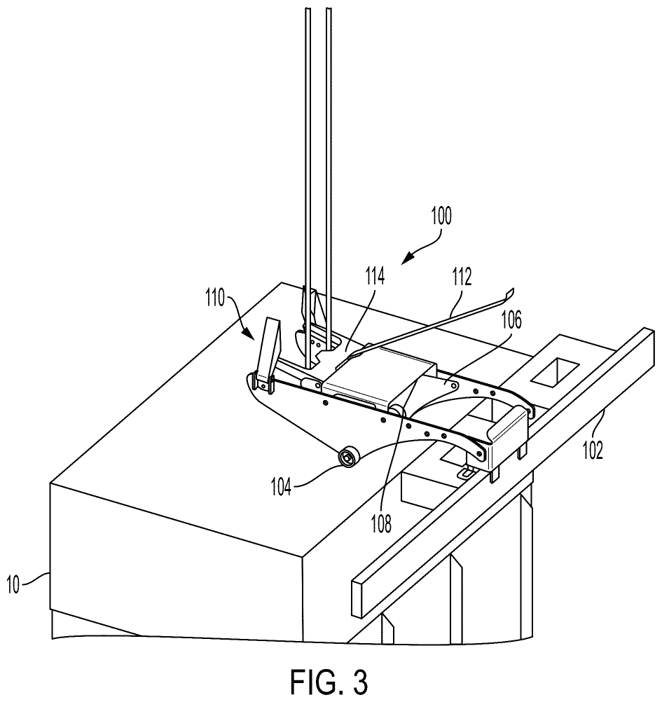

Referring to FIG. 3, a perspective view of the elevator cable management system 100 with the gate 110 in an open position is shown, according to an exemplary embodiment. The inner body 150 functions to open and close the gate 110 that encloses one or more cables 15. In this way, the gate 110 is configured to transition between an open position and a closed position to retain and/or release the cables 15. The gate 110 serves as a retainer for the cables 15 by closing off the opening 175. In this way, the gate 110 provides a physical constraint on the movement of the cables 15 inside the elevator shaft. The gate 110 is coupled to the side pieces 103 using hinges 118. In this way, the arms 111 and 113 rotate about the side pieces 103 (e.g., about axis (A)) of the elevator cable management system 100 to open and close the gate 110. Although two arms are shown, any suitable number of arms may be used to enclose the cables 15 (e.g., 1, 3, 4, etc.). In some examples, the arms 111 and 113 of the gate 110 are made of plastic. In some embodiments, the arms 111 and 113 may be made of metal or any other suitable material.

The inner body 150 operates to move the gate 110 from a closed position to an open position, and vice versa. By way of example, as the elevator car 10 moves upward and makes first contact with the inner body 150 at the internal rollers 108, the elevator car 10 pushes the inner body 150 about axis (C) (as shown in FIG. 2) from a disengaged position to an engaged position. As referred to herein, the disengaged position refers to the inner body 150 being in a position wherein at least a portion of the legs 106 are below the side pieces 103 of the outer body 160. As referred to herein, the engaged position refers to the inner body 150 being in a position wherein the legs 106 are planar with or above the side pieces 103. The inner body 150 continues to move upward until the external rollers 104 make contact with the top of the elevator car 10 and/or the inner top plate 152 makes contact with the top plate 116. In the engaged position, the inner body 150 is configured to rotate with the outer body 160, such that the inner body 150 and the outer body 160 rotate as one arm.

Referring to FIGS. 4-6, sequential perspective views of the arm defined by the inner body 150 and the outer body 160 (i.e., “the arm”) in a tilted position are shown, according to exemplary embodiments. Once the top of the elevator car 10 makes contact with the external rollers 104, the elevator car 10 pushes the second arm or outer body 160 and the engaged first arm or inner body 150 upward, to rotate about the mount 120 (e.g., about axis (B)). The external rollers 104 roll along the top surface of the elevator car 10 as the elevator cable management system 100 continues to tilt towards the wall of the elevator shaft. Although shown as rollers, the external rollers 104 may be any mechanism suited to facilitate sliding along surfaces of the elevator car 10.

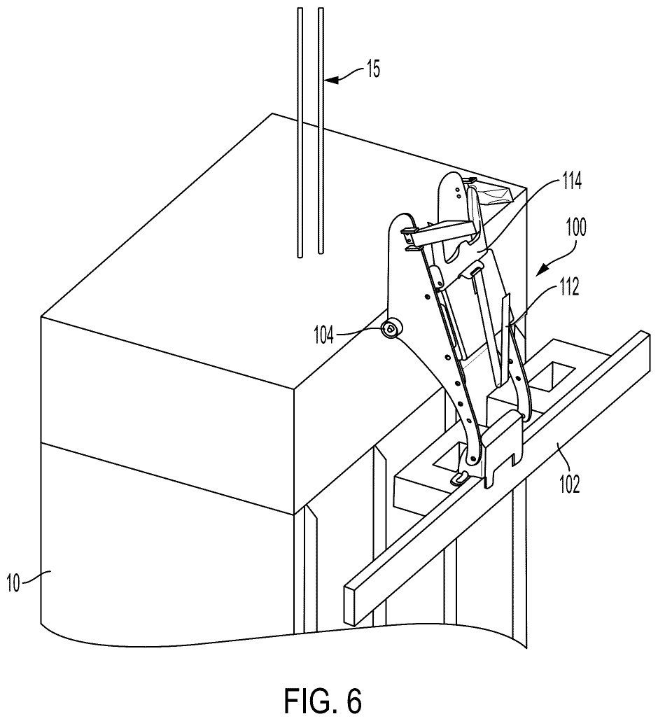

As the arm rotates towards the wall of the elevator shaft, tension is released from the stop 112. Since the inner body 150 moved the arms 111 and 113 of the gate 110 into the open position, the cables 15 are free to pass through the open gate 110. In this way, the arm is able to move past the cables 15 and reach a retracted position (e.g., an upward, substantially vertical, or vertical position) as shown in FIG. 6. As referred to herein, the “retracted position” means positioned such that the arm is aside the elevator car 10 when the elevator car 10 moves past the arm or otherwise moved to a position that does not impede the movement of the elevator. By way of example, the retracted position includes the arm being parallel with, or within 10 to 20 degrees of being parallel with, the wall of the elevator shaft, the cables 15, or a surface of the elevator car 10.

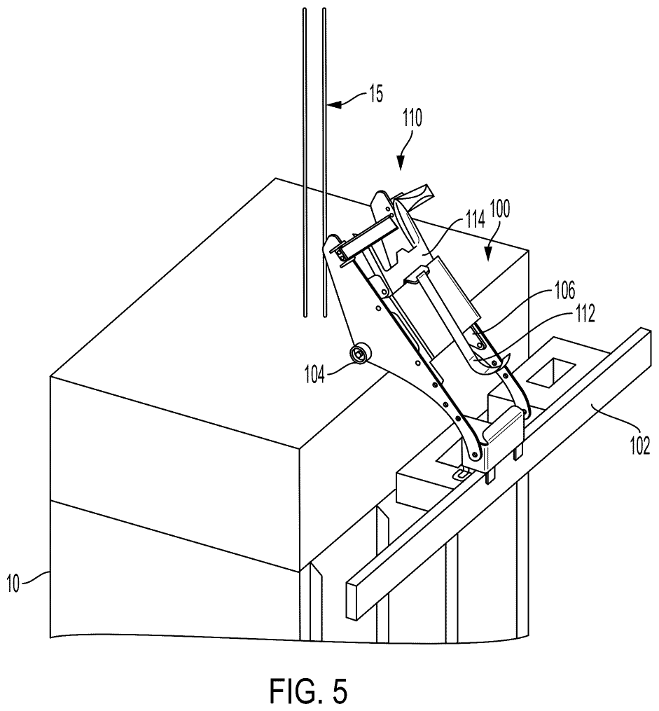

Referring to FIGS. 7-10, sequential perspective views of the elevator cable management system 100 as the elevator car 10 moves respective of the elevator cable management system 100 are shown, according to exemplary embodiments. Once the arm defined by the outer body 160 and the inner body 150 in the engaged position is pushed into the retracted position (as shown in FIG. 5), the external rollers 104 remain in contact with a surface of the elevator car 10 as the elevator car 10 moves upward in the elevator shaft. In exemplary embodiments, the elevator cable management system 100 is mounted to the support 102 such that it remains in contact with a back side surface of the elevator car 10 when the elevator car 10 moves upward in the elevator shaft.

As shown in FIGS. 7-9, the back side of the elevator car 10 includes a retainer bracket 12. The retainer bracket 12 retains one or more cables 15. The cables 15 are routed from the top of the elevator car 10, through an interior of the elevator car 10, and to the exterior of the elevator car 10, such that the cables 15 exit from a side of the elevator car 10. In exemplary embodiments, the exiting cables 15 are steel wires or steel ropes connected to a traction hoist for lifting and lowering the elevator car 10. Other types of cables, such as electrical cables, or optical cables for communications, can also be managed by the elevator cable management system 100.

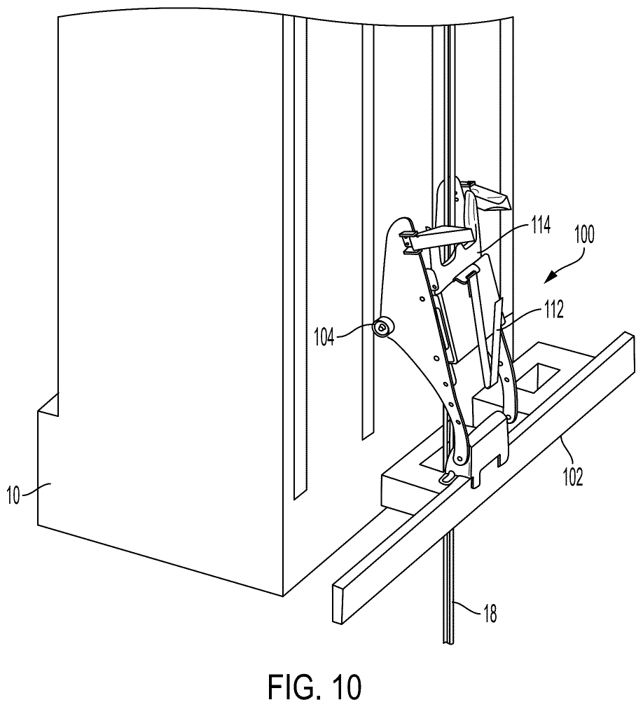

In an example, the cables 15 extend through a retainer bracket 12 affixed to a side of the elevator car 10. In this example, the retainer bracket 12 contacts the underside of the elevator cable management system 100 (e.g., the inner top plate 152) as the elevator car 10 travels upward in the elevator shaft. This contact pushes the arm to tilt slightly backward. Once the retainer bracket 12 passes the elevator cable management system 100, the elevator cable management system 100 comes into contact with the cables 15 that extend from the bottom of the retainer bracket 12. As shown in FIG. 10, the inner body 150, and particularly, the actuator 114 rests on/engages the cables 15. In some embodiments, the arm does not make contact with the back side of the elevator car 10 while the inner body 150 rests on the cables 15. In some examples, the elevator car 10 does not include a retainer bracket 12. Instead, the cables 15 may extend from an opening in a side of the elevator car 10. In this example, the arm remains in contact with the elevator car 10 until the elevator car 10 passes the elevator cable management system 100.

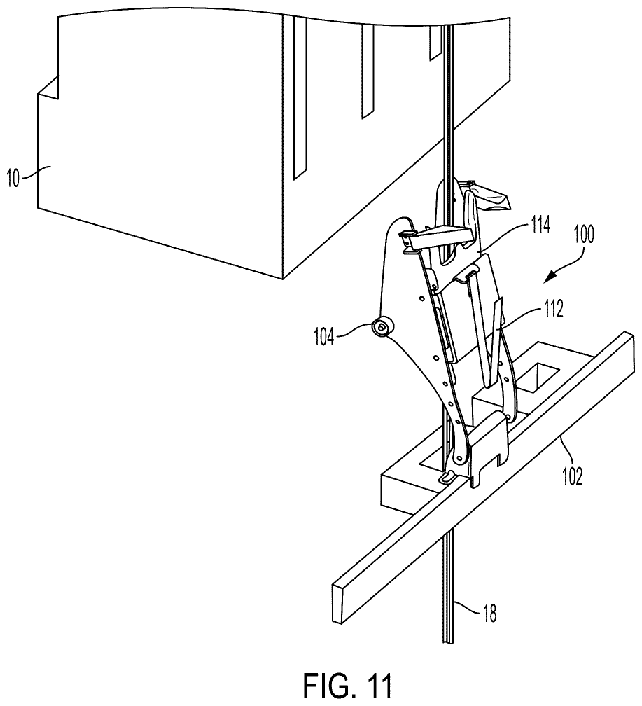

Referring to FIG. 11, a perspective view of the arm defined by the outer body 160 and the inner body 150 in the engaged position is shown in the retracted position, according to an exemplary embodiment. Once the elevator car 10 passes the elevator cable management system 100, the arm remains in the retracted position by resting on the cables 15. In some examples, the arm remains in the retracted position by resting on other cables, such as electrical cables, optical cables, traveling cables, or anything of the like. In exemplary embodiments, the arm remains in the retracted position until the elevator car 10 passes the elevator cable management system 100 in an opposite direction (e.g., when coming back down the elevator shaft).

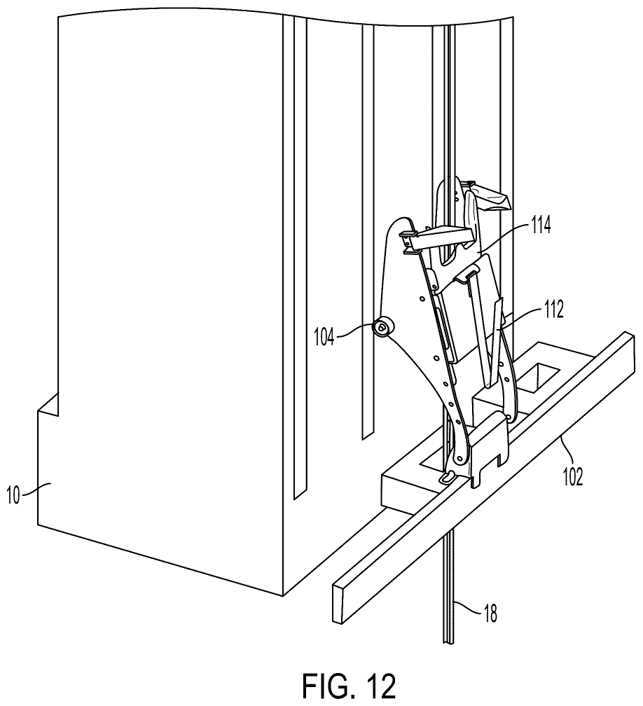

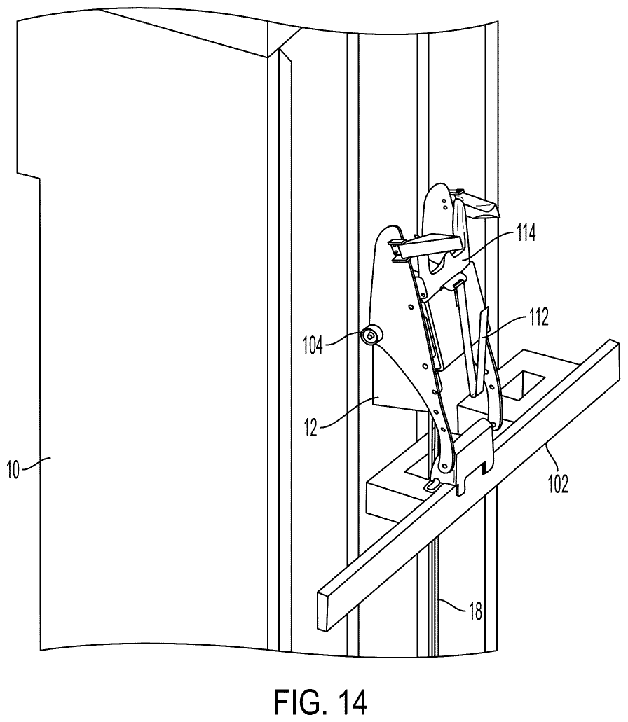

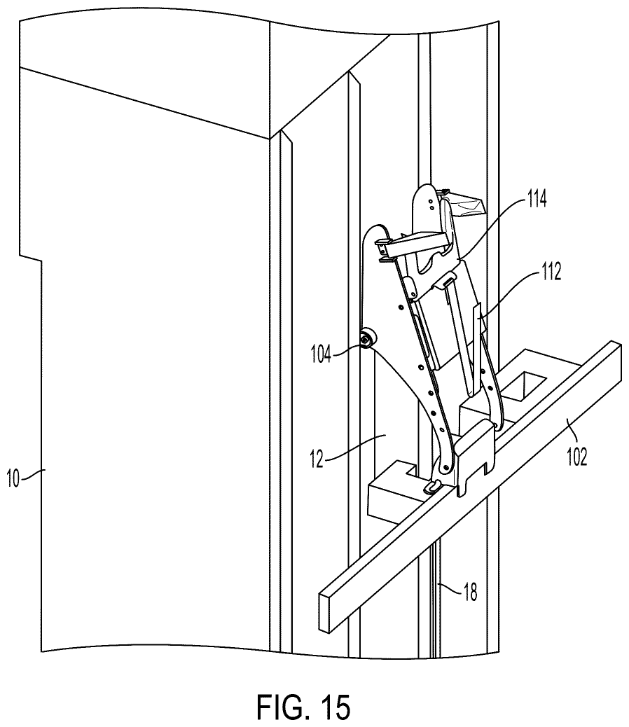

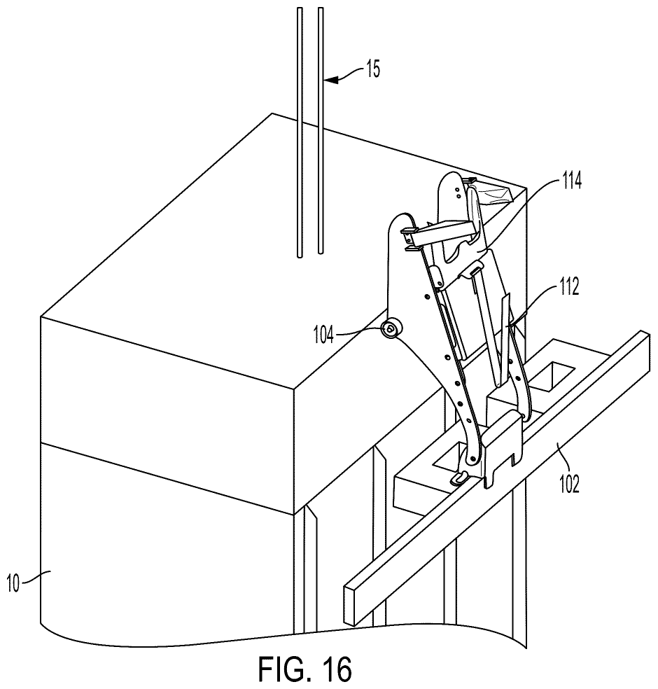

Referring to FIGS. 12-16, sequential perspective views of the elevator cable management system 100 are shown, according to exemplary embodiments. In FIGS. 12-16, the elevator car 10 is traveling downward through the elevator shaft. The arm continues to rest against the cables 15 until passing the exit point of the cables 15 in the side of the elevator car 10 (e.g., the retainer bracket 12). As discussed above, the retainer bracket 12 pushes the arm slightly backward such that the arm is vertical or angled slightly away from the cables 15, or elevator car 10, and towards the elevator wall. Once the retainer bracket 12 passes the elevator cable management system 100 when the elevator car 10 is traveling downward, the arm tilts back toward the elevator car 10 until the external rollers 104 come into contact with the back side of the elevator car 10.

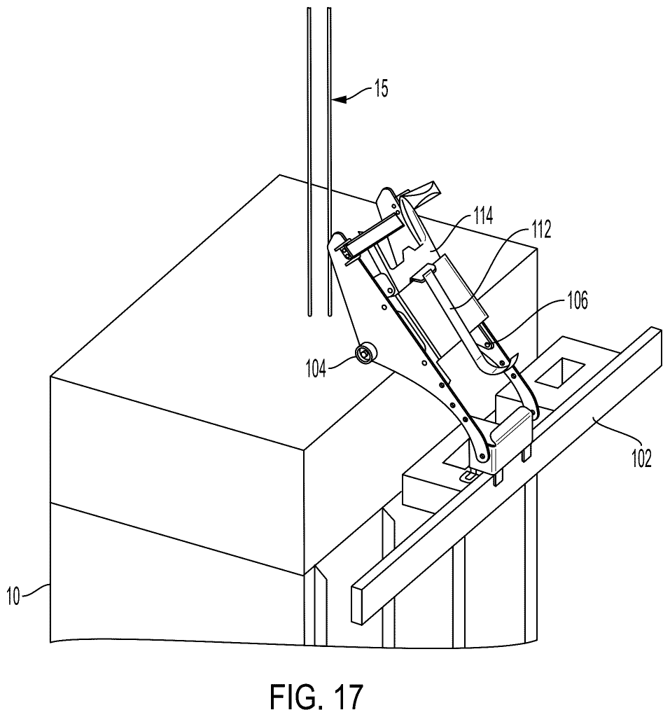

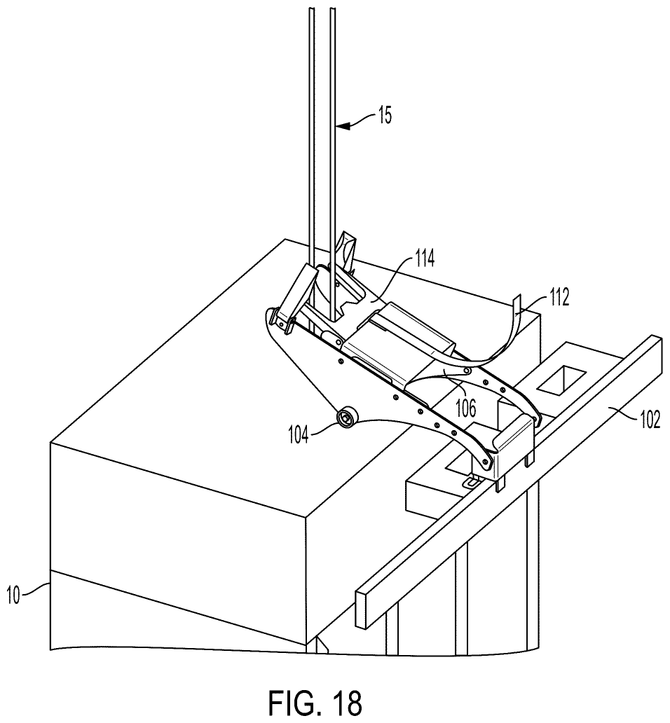

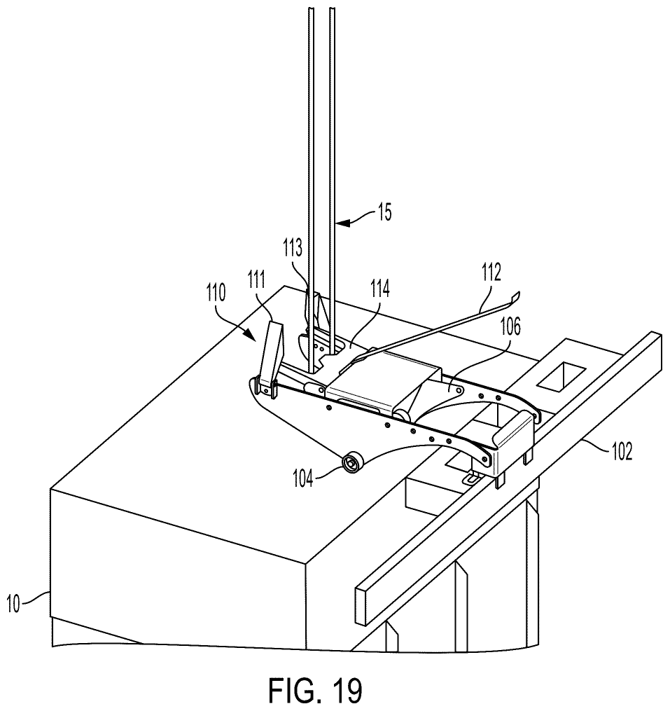

Referring now to FIGS. 17-20, sequential perspective views of the elevator cable management system 100 are shown, according to exemplary embodiments. In FIGS. 17-19, the elevator car 10 is traveling downward through the elevator shaft, and the top of the elevator car 10 is passing the elevator cable management system 100. The external rollers 104 roll from the back side of the elevator car 10 to the top side as the elevator car 10 travels downward. In some examples, gravity causes the arm to rotate downward about the support 102. In other examples, the elevator cable management system 100 includes a spring that introduces torsional force to cause the arm to rotate downward about the mount 120. The rotational motion of the arm is limited by the stop 112 (e.g., by introducing tension into a fabric strap, by abutting a fixed stopper, etc.). As shown in FIG. 19, the second arm or outer body 160 partially encloses the cables 15 once in the extended position. In FIG. 19, the top surface of the elevator car 10 continues to exert an upward force on the inner body 150. In this way, the inner body 150 remains pushed upward to maintain the gate 110 in an open position.

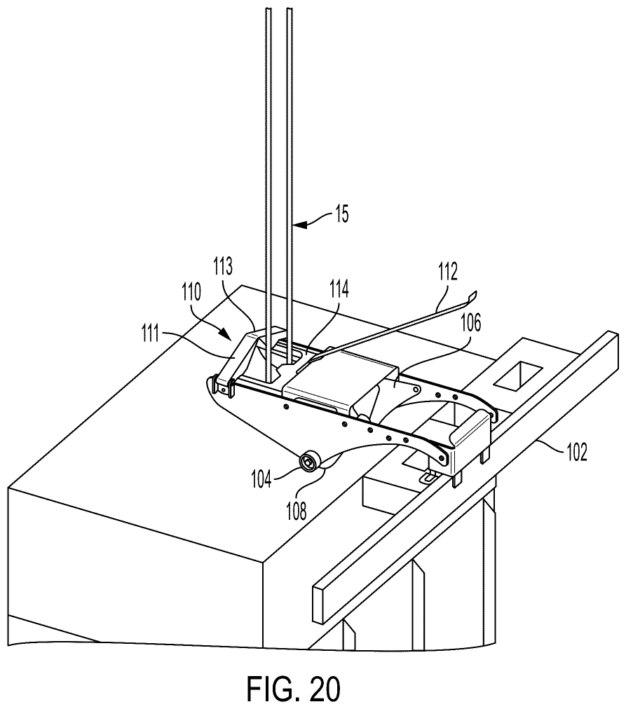

As shown in FIG. 20, once the elevator car 10 passes the elevator cable management system 100 such that the elevator car 10 is no longer in contact with the elevator cable management system 100, the inner body 150 lowers to return to the disengaged position. In this example, the legs 106 and the internal rollers 108 return to a position below the external rollers 104. This lowering motion also lowers the actuator 114, which in turn, lowers the arms 111 and 113 of the gate 110 to a closed position around the cables 15 to surround or otherwise retain the cables 15.

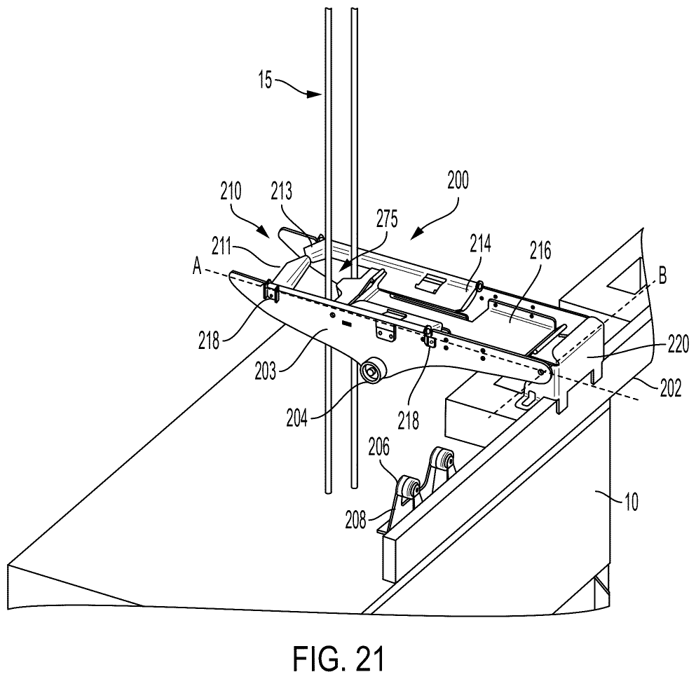

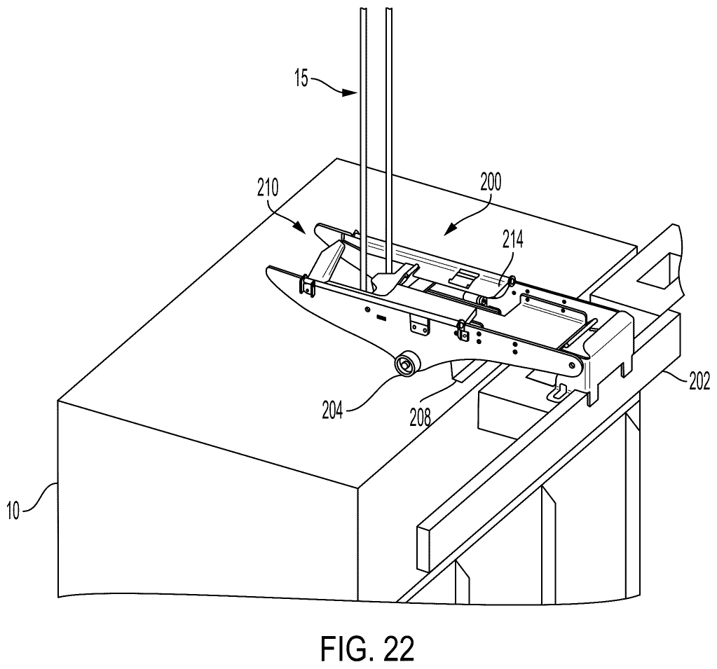

Referring to FIGS. 21 and 22, a perspective view of an elevator cable management system 200 is shown, according to exemplary embodiments. In FIGS. 21 and 22, the elevator car 10 or cabin moves upward through the elevator shaft. The elevator car 10 includes a bracket 208 having sliders or rollers 206 that is coupled to the top surface of the elevator car 10. The elevator cable management system 200 is coupled with a support 202 via a mount 220. The support 202 affixes the elevator cable management system 200 to a structure, such as a platform, a gallery wall, or a wall of the elevator shaft. The elevator cable management system 200 includes a gate 210, external rollers 204, side pieces 203, mount 220, and a top plate 216. The side pieces 203 and top plate 216 define an arm (i.e. “the arm”) configured to rotate about the mount 220.

The elevator cable management system 200 utilizes the gate 210 to enclose the cables 15 and provide a physical constraint on the movement of the cables 15 inside the elevator shaft. The gate 210 includes a pivoting portion 214 configured to engage with the bracket 208 having sliders or rollers 206 affixed to the top of the elevator car 10. The gate 210 is shown to include two arms 211, 213 that meet at a center point between the side pieces 203. Similar to the elevator cable management system 100, the body of the elevator cable management system 200 includes a top plate 216 coupled with two side pieces 203. External rollers 204 are coupled with a bottom side (i.e., the side closest to the bottom of the elevator shaft) of the side pieces 203. The side pieces 203 extend past top plate 216, and the arms 211, 213 extend perpendicularly from the side pieces 203 at the end of the gate 210 furthest from the top plate 216. In this way, the top plate 216, side pieces 203, and gate 210 form an opening 275 through which the cables 15 are retained. In exemplary embodiments, the body of the elevator cable management system 200 and the gate 210 are positioned such that there is space between the cables 15 and the surrounding side pieces 203, top plate 216, and gate 210. In this way, the cables 15 may occasionally come into contact with the elevator cable management system 200 when swaying but are prevented from coming into contact with other components of the elevator system, such as the elevator shaft, platforms, or other cables, among other components. The side pieces 203 are pivotably coupled with the mount 220, such that the arm can rotate about the mount 220 responsive to movement by the elevator car 10. In exemplary embodiments, the arm, or more specifically, the side pieces 203, rest against a portion of the support 202 while in an extended position. In this way, the support 202 serves to limit the rotational motion of the cable management system 200. However, the arm may rest against any style of stop to limit the movement of the arm relative the mount 220 and position the arm in the extended position.

In some examples, the arms 211, 213 and the pivoting portion 214 are unitary members that extend from around a midline of the elevator cable management system 200 to around the end of the body of the elevator cable management system 200. The gate 210 and pivoting portion 214 are pivotably coupled via pivot points 218 to the side pieces 203, such that the arms 211, 213 can rotate about the side pieces 203 (e.g., about axis (A)) to open and close the gate 210. Although two arms 211, 213 are shown, any suitable number of arms may be used to enclose the cables 15 (e.g., 1, 3, 4, etc.). In exemplary embodiments, the gate 210 is made of plastic; however, the gate 210 may be made of metal or any other suitable material. In some embodiments, the arms 211, 213 comprise a different material from the pivoting portion 214. As the elevator car 10 travels upward through the elevator shaft, the bracket 208 and sliders/rollers 206 on the top of the elevator car 10 come into contact with the pivoting portion 214 of the elevator cable management system 200. As shown in FIG. 22, the pivoting portion 214 causes the arms 211, 213 to begin rotating upward and outward, about axis (A), upon initial contact with the bracket 208 and sliders/rollers 206.

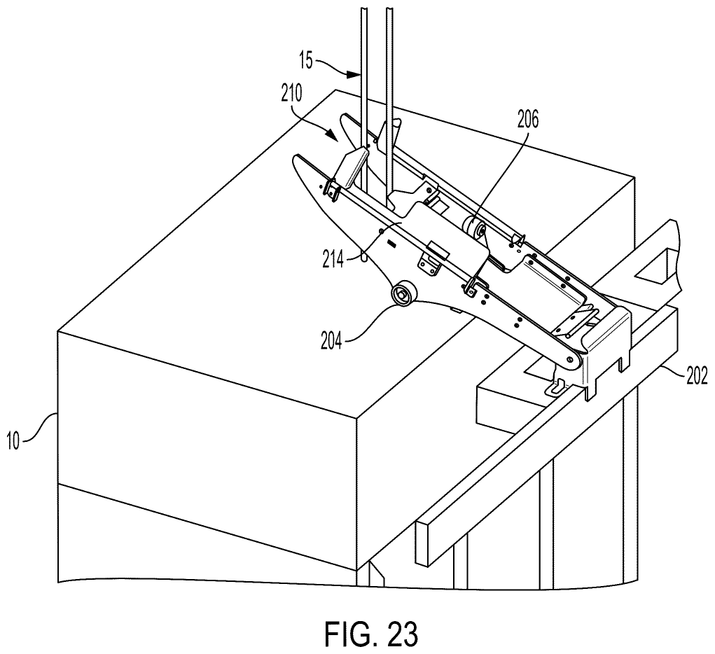

Referring to FIG. 23, a perspective view of the elevator cable management system 200 with the gate 210 open is shown, according to an exemplary embodiment. As the elevator car 10 travels upward through the elevator shaft, the bracket 208 and sliders/rollers 206 on the top surface of the elevator car 10 come into contact with the pivoting portion 214 of the arm of the elevator cable management system 200. The sliders/rollers 206 and bracket 208 cause the pivoting portion 214 and the arms 211, 213 to rotate upward and outward about axis (A) into an open position.

Simultaneously, or nearly simultaneously, the external rollers 204 come into contact with a top surface of the elevator car 10. The top surface exerts force on the external rollers 204 as the elevator car 10 travels upward in the elevator shaft. This force causes the arm to tilt upward (e.g., about the mount 220, about axis (B)) from the extended position relative to the wall of the elevator shaft the support 202 is affixed to. The open gate 210 allows the arm of the elevator cable management system 200 to rotate past the cables 15 as the arm tilts upward, about axis (B). As the arm tilts upward, the external rollers 204 roll across the top surface of the elevator car 10, until the elevator cable management system 200 reaches the edge of the top side, and then the external rollers 204 roll along the back side of the elevator car 10.

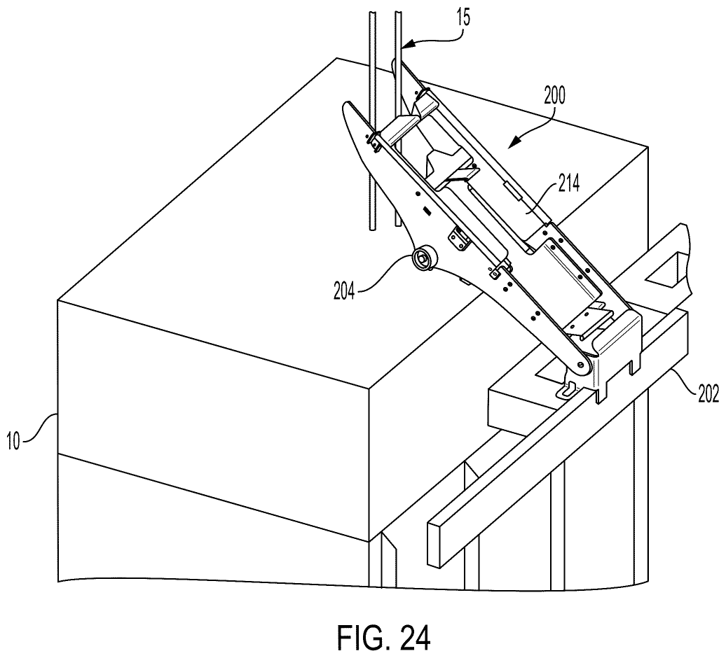

Referring to FIG. 24, a perspective view of the elevator cable management system 200 tilted with the gate 210 closed is shown, according to an exemplary embodiment. As the elevator car 10 continues to move respective of the elevator cable management system 200, arm continues to further tilt upward toward the retracted position (e.g., a position aside the elevator car 10, a substantially vertical, or a vertical position). Once the arm is tilted to a threshold angle, the pivoting portion 214 of the gate 210 no longer contacts the bracket 208 and sliders/rollers 206. At this point, the arms 211, 213 and pivoting portion 214 rotate downward and inward to close the gate 210.

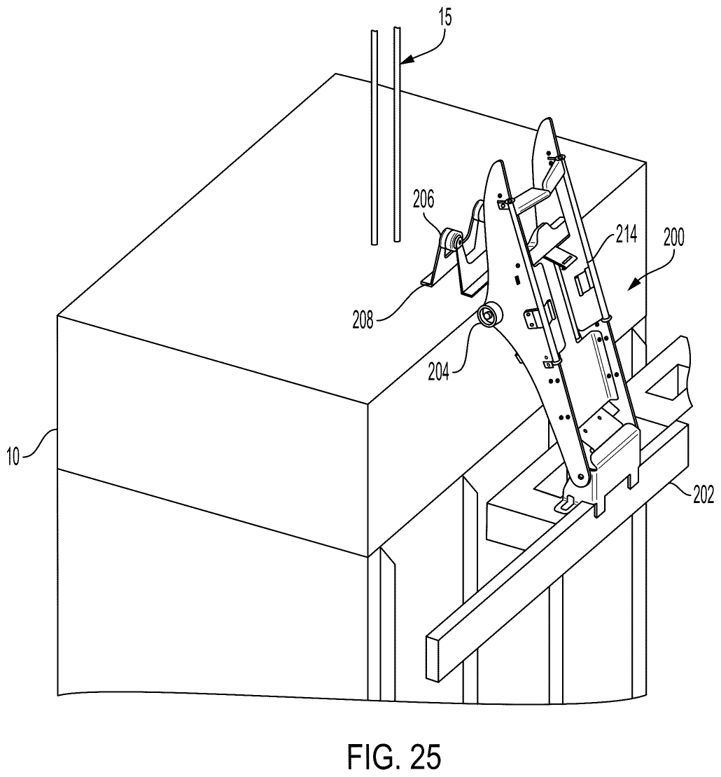

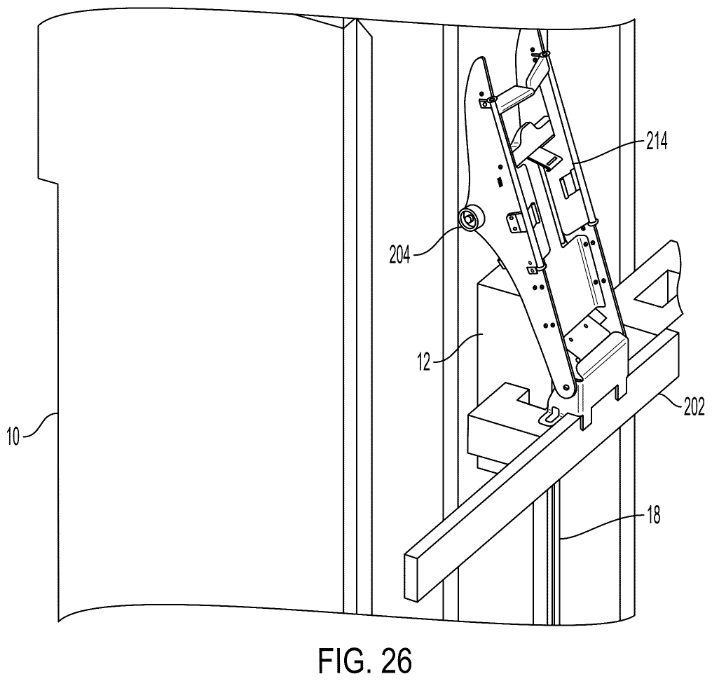

Referring to FIGS. 25-26, sequential perspective views of the elevator cable management system 200 are shown, according to exemplary embodiments. Once the arm of the elevator cable management system 200 is in a retracted position (e.g., aside the elevator car 10, upright, vertical, or substantially vertical), the external rollers 204 begin to roll along the back side of the elevator car 10 as the elevator car 10 moves upward through the elevator shaft. The retainer bracket 12 contacts the underside of the top plate 216 as the elevator car 10 travels upward in the elevator shaft. This pushes the arm to tilt backward, such that the arm is angled slightly away from the cables 15 or elevator car 10 or towards the elevator wall. Once the retainer bracket 12 passes the elevator cable management system 200, the arm comes into contact with the cables 15 extending from the bottom of the retainer bracket 12 (i.e., the trailing cables 15). In exemplary embodiments, the arm, and specifically the top plate 216 rests on/engages the cables 15. In some embodiments, the arm does not make contact with the back side of the elevator while the arm rests on the cables 15 via contact with the top plate 216. In some examples, the elevator car 10 does not include the retainer bracket 12. As discussed above, the cables 15 may extend from an opening in a side of the elevator car 10. In this example, the arm remains in contact with the elevator car 10 until the elevator car 10 passes the elevator cable management system 200.

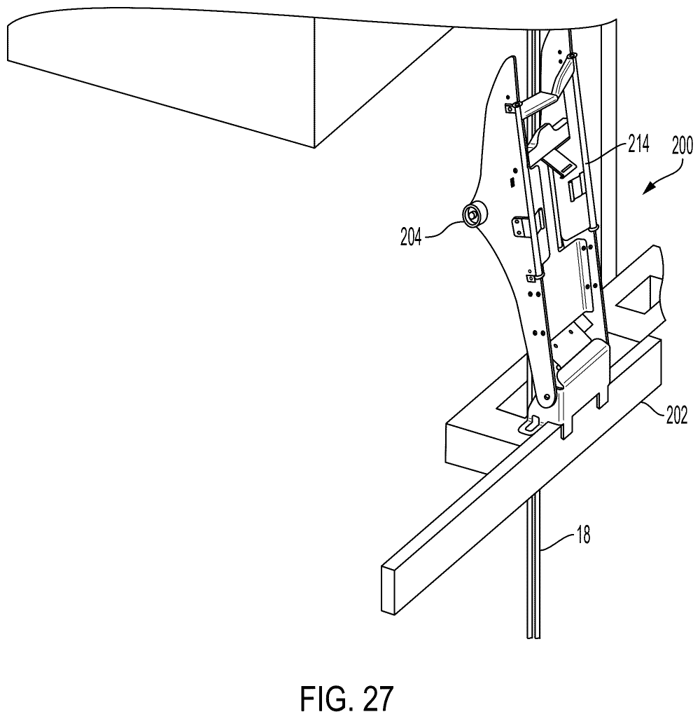

Referring to FIG. 27, a perspective view of the arm of the elevator cable management system 200 in the retracted position is shown, according to an exemplary embodiment. Once the elevator car 10 passes the elevator cable management system 200, the arm is held in the retracted position by the cables 15. The arm remains in the retracted position until the elevator car 10 passes the elevator cable management system 200 in an opposite direction (e.g., when coming back down the elevator shaft). In some examples, the arm is held in the retracted position by electrical cables, optical cables, traveling cables, or anything of the like.

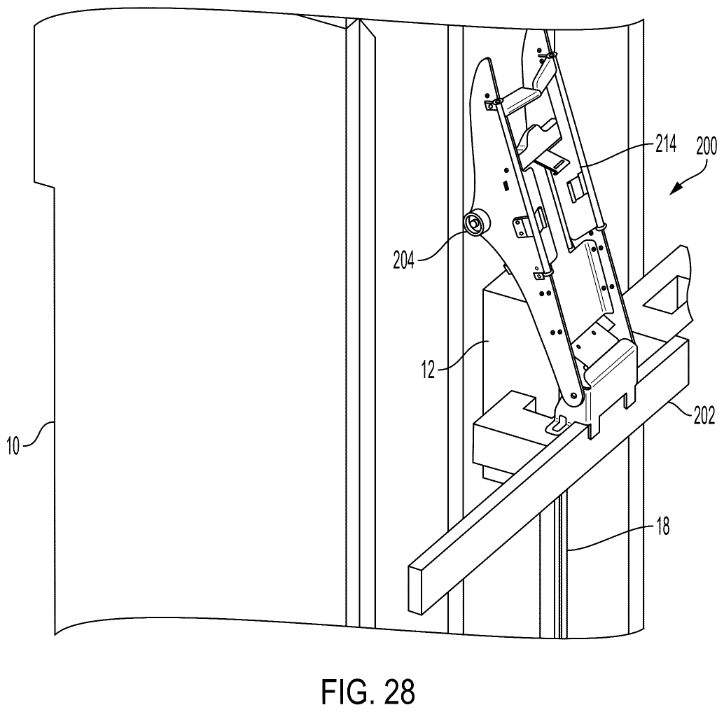

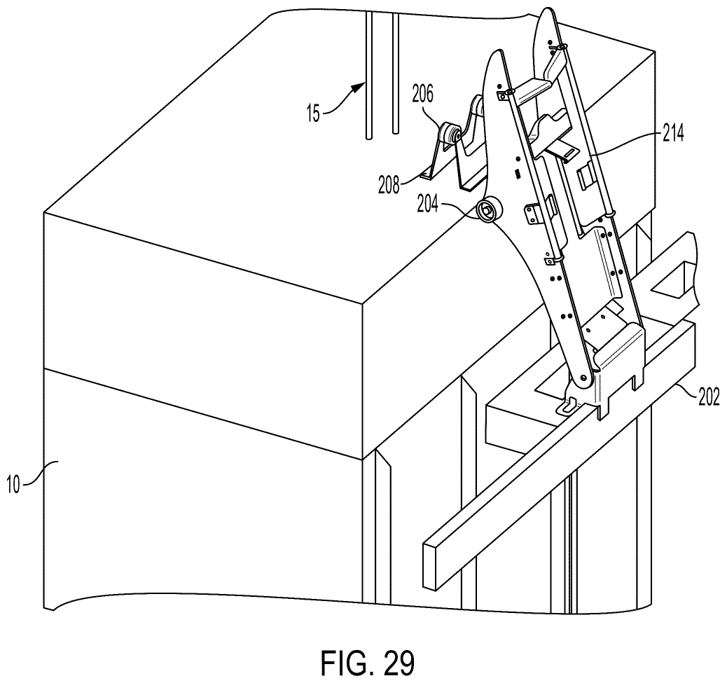

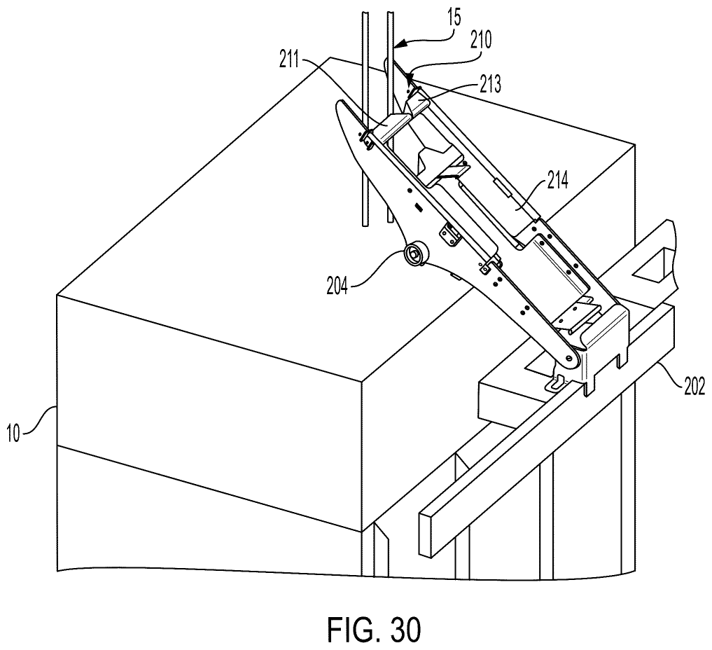

Referring to FIGS. 28-32, sequential perspective views of the elevator cable management system 200 as the elevator car travels downward through the elevator shaft are shown, according to exemplary embodiments. The arm of the elevator cable management system 200 continues to rest against the cables 15 until coming into contact with the retainer bracket 12. As discussed above, the retainer bracket pushes the arm backward, such that the arm is angled slightly away from the cables 15, or elevator car 10, or towards the elevator wall. Once the retainer bracket 12 passes the arm, the arm tilts back toward the elevator car 10 until the external rollers 204 come into contact with the back side of the elevator car 10.

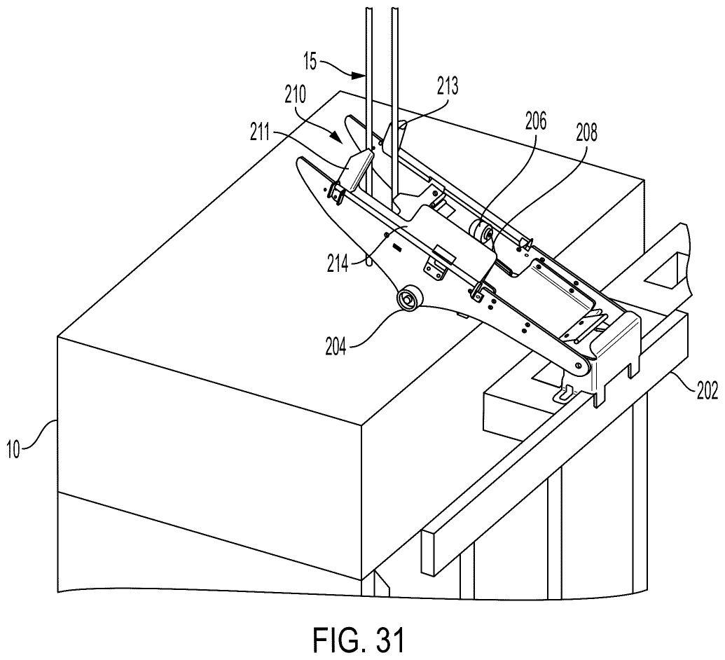

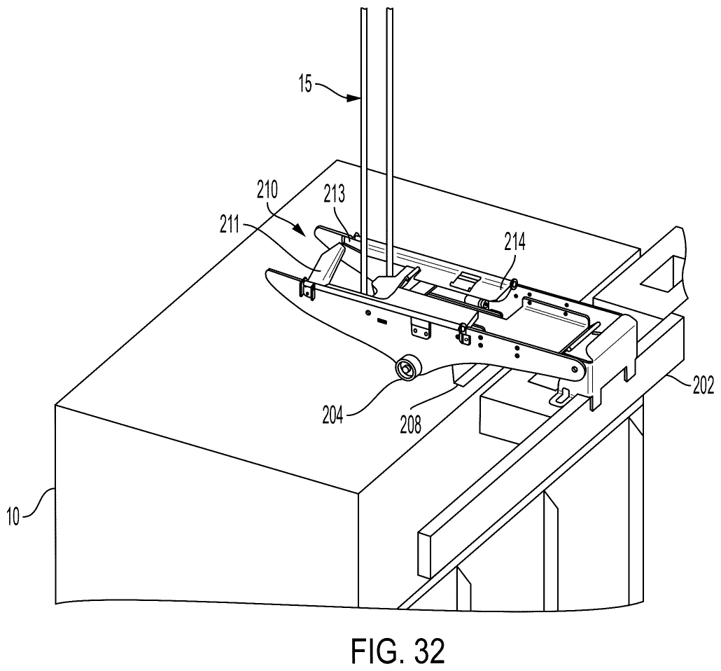

The external rollers 204 roll from the back side of the elevator car 10 to the top surface as the elevator car 10 travels downward. A force (e.g., gravity, torsional force from a spring, etc.) causes the arm to rotate downward about the mount 220 once the arm reaches the top surface of the elevator. As the arm rotates downward, the pivoting portion 214 makes contact with the sliders/rollers 206 and bracket 208 affixed to the top surface of the elevator car 10. As shown in FIG. 31, the arms 211, 213 of the gate 210 are rotated open by the sliders/rollers 206 and the bracket 208 to enable the elevator cable management system to surround and enclose the cables 15. As shown in FIG. 32, the elevator cable management system 200 continues to rotate downward until it reaches the extended position, in which the elevator cable management system 200 rests against a portion of the support 202 (e.g., a stop). In this position, the pivoting portion 214 no longer contacts the sliders/rollers 206 or the bracket 208, which causes the arms 211, 213 to rotate downward and inward about axis (A) to close the gate 210. Once closed, the gate 210 encloses the cables 15 to retain the cables 15 to prevent the cables 15 from coming into contact with other components of the elevator system, such as the elevator shaft, platforms, or other cables, among other components.

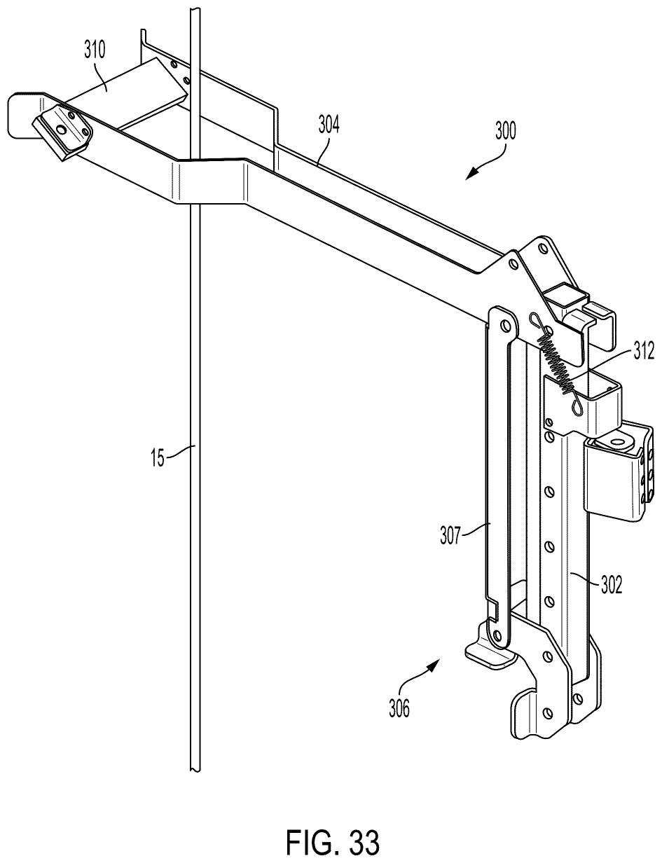

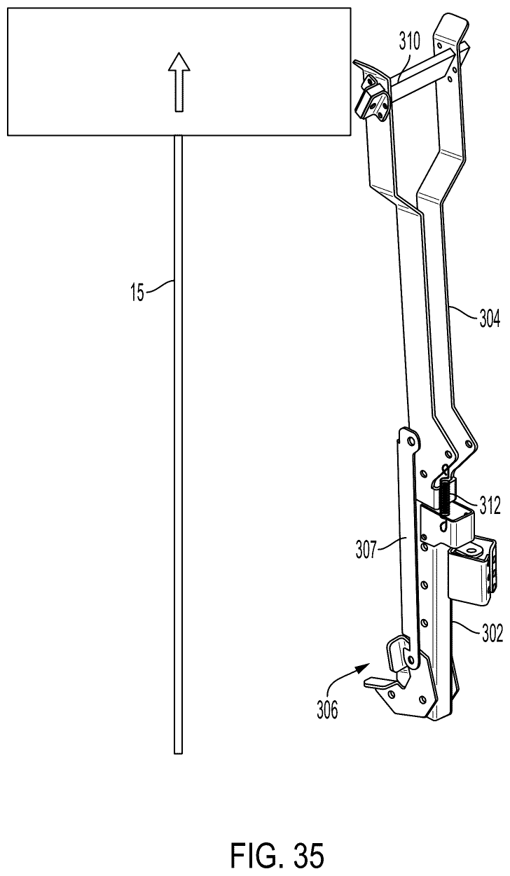

Referring now to FIG. 33, a perspective view of an elevator cable management system 300 is shown, according to an exemplary embodiment. The elevator cable management system 300 includes a first arm 302 that is mounted to a wall of the elevator shaft and a second arm 304 pivotably coupled to the first arm 302. The first arm 302 is mounted to such that the second arm 304 is perpendicular or substantially perpendicular to the first arm 302. The first arm 302 and the second arm 304 are joined by one or more springs 312. In exemplary embodiments, the spring 312 is a bistable spring that causes the elevator cable management system 300 to lock in a first position (as shown in FIG. 33) and cause the elevator cable management system 300 to lock in a second position (as shown in FIG. 35). The second arm 304 includes a pronged end, which may be, for example, U-shaped, V-shaped, or circular, though it will be appreciated that the pronged end may be any shape. A retaining mechanism 310 extends from one prong end to the other prong end. In exemplary embodiments, the retaining mechanism 310 is a pair of flexible strips made of rubber, a flexible polymer, or any other suitable material. The retaining mechanism 310 and prongs enclose the cables 15, such that movement of the cables 15 is restrained to the opening defined by the prongs and the retaining mechanism 310. In this example, the second arm 304 includes two rubber strips, but any suitable number of strips may be used (e.g., 3, 4, etc.). The first arm 302 includes an interface mechanism on a bottom portion. The interface mechanism is shown as a C-shaped mechanism 306 coupled with an extension 307 that extends from the bottom portion of the first arm 302 to the base of the second arm 304.

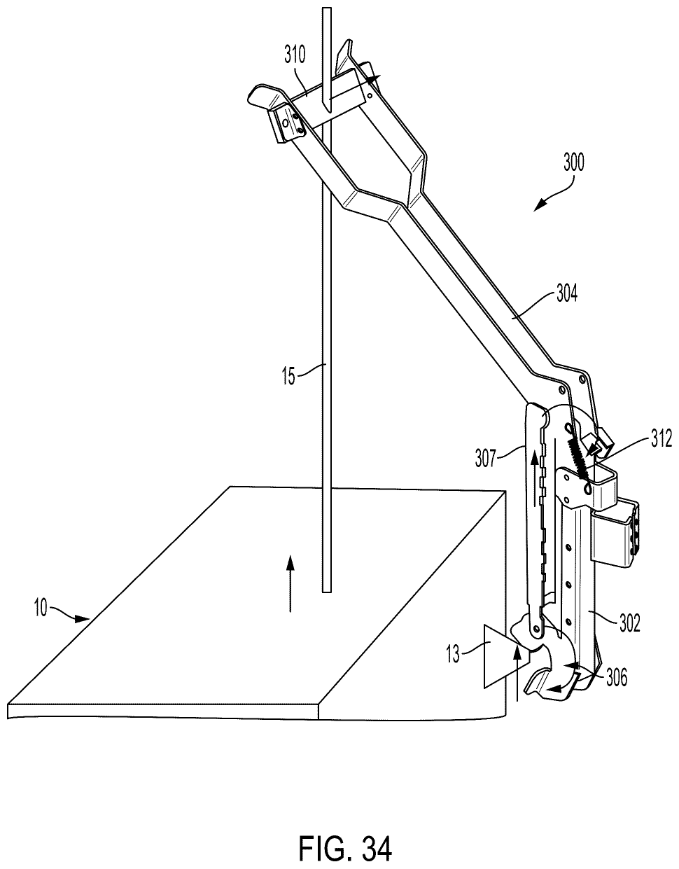

Referring to FIG. 34, a perspective view of the elevator cable management system 300 being tilted upward is shown, according to an exemplary embodiment. An activator bracket 13 on the elevator car 10 pushes the C-shaped mechanism 306 in a first direction which thereby causes the extension 307 of the C-shaped mechanism 306 to move upwards. In some examples, the retainer bracket 12 serves as the activator bracket 13. In other examples, the activator bracket 13 is a separate component from the retainer bracket 12. For example, the activator bracket 13 may be positioned on a surface of the elevator 10, while no retainer bracket 12 is present. This in turn pushes the second arm 304 upwards at its base, such that the second arm 304 rotates about the first arm 302. In this example, the cables 15 pass through the retaining mechanism 310, such that the cables 15 move from the interior of the prongs to the exterior of the prongs. For example, the cables 15 push through a slit or opening defined by two flexible strips placed opposite one another at the pronged end of the second arm 304, as the second arm 304 rotates upwards or downwards. The spring 312 assists with this movement by applying a force to pull the second arm 304 upward into a substantially vertical or vertical position.

Referring to FIG. 35, a perspective view of the elevator cable management system 300 in a vertical position is shown, according to an exemplary embodiment. As shown, the C-shaped mechanism 306 causes the second arm 304 to pivot into a vertical position when engaged by the activator bracket 13 of the elevator car 10 as the elevator car 10 passes the elevator cable management system 300.

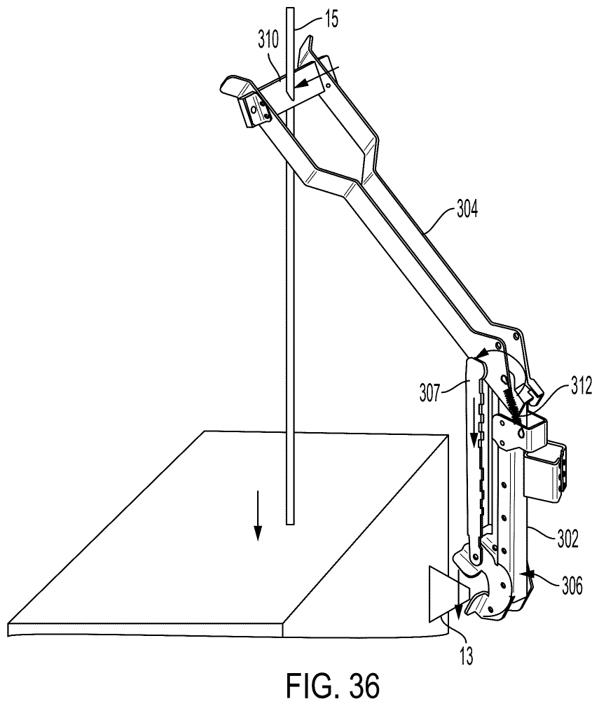

Referring to FIG. 36, a perspective view of the elevator cable management system 300 with the second arm 304 being tilted back downward is shown, according to an exemplary embodiment. As the elevator car 10 travels downward, the C-shaped mechanism 306 is contacted by the activator bracket 13. The activator bracket 13 pushes the C-shaped mechanism 306 in a second direction, which causes the extension 307 to pull the second arm 304 downward, thereby rotating the second arm 304 downwards back towards the starting position. The retaining mechanism 310 engages the cables 15 as the second arm 304 rotates downwards, which causes the cables 15 to pass through the retaining mechanism 310. The second arm 304 continues to rotate downwards until the spring 312 returns to the first position. As shown in FIG. 33, once the spring 312 reaches the first position, the spring 312 locks the second arm 304 into place. In this position, retaining mechanism 310 retains the cables 15 to prevent the cables 15 from coming into contact with other components of the elevator system, such as the elevator shaft, platforms, or other cables, among other components.

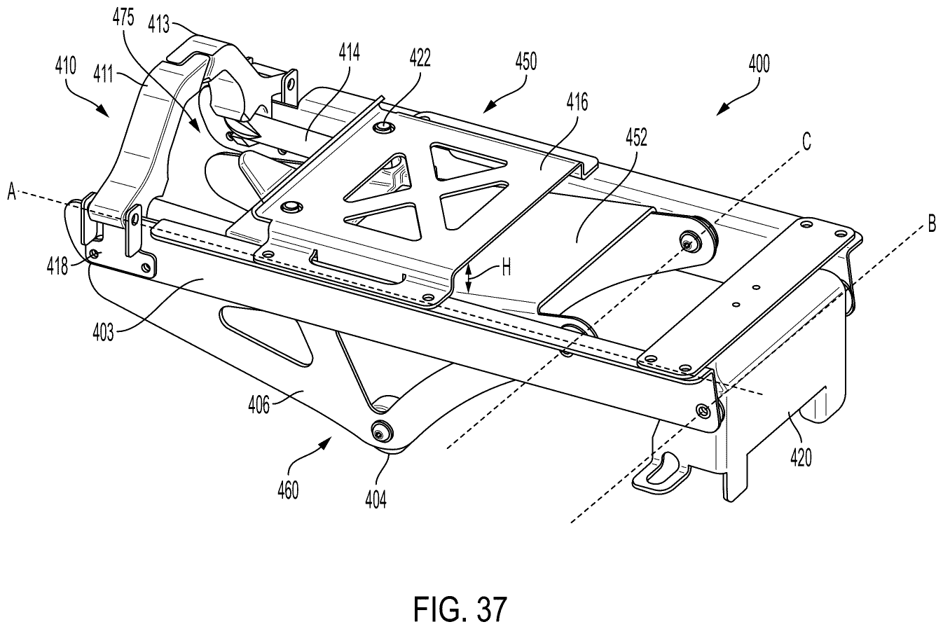

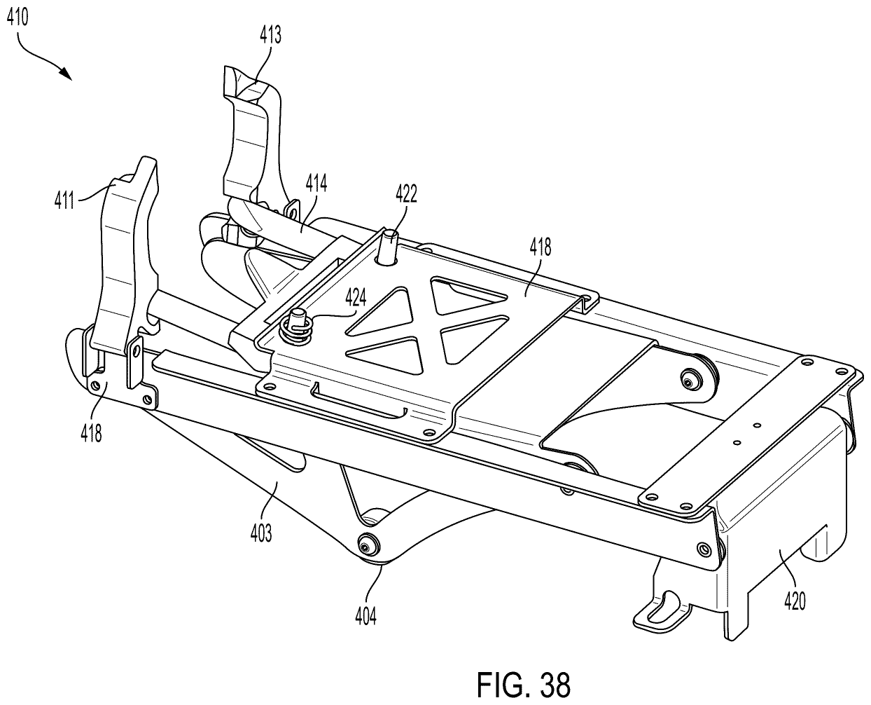

Referring to FIGS. 37 and 38, perspective views of an elevator cable management system 400 are shown, according to an exemplary embodiment. The elevator cable management system 400 includes a first arm or an inner body 450 and a second arm or an outer body 460.

The inner body 450 includes legs 406 coupled with an inner top plate 452. The legs 406 are coupled with an actuator 414 having fingers and with rollers 404. In exemplary embodiments, the legs 406 are relatively triangular. In this example, the legs 406 are coupled with the rollers 404 at the apex. The actuator 414 includes one or more pegs 422. In some embodiments, a spring 424 is disposed around the pegs 422. The spring 424 serves to absorb impact as the elevator car 10 engages with the elevator cable management system 400 and/or to push the inner body 450 downward into the disengaged position (e.g., when a force in addition to the force of gravity is required to move the inner body 450 relative to the outer body 460). The inner body 450 functions to open and close the gate 410 that enclose one or more cables 15 in a space or opening 475 defined by the gate 410, the side pieces 403, and the actuator 414.

The outer body 460 includes the top plate 416 coupled with side pieces 403. The side pieces 403 are shown to extend past the top plate 416. A gate 410 includes one or more arms 411, 413. As shown, the gate 410 includes two arms 411, 413 that meet at a center point between the side pieces 403. The arms 411, 413 are hingedly coupled with the side pieces 403 via hinges 418 at the front end. The actuator 414 is operatively coupled with a base of arms 411, 413, such that the fingers of the actuator 414 push the arms 411, 413 upward to open. The side pieces 403 are pivotably coupled with a mount 420 at an end opposite the gate 410, according to exemplary embodiments. The top plate 416 includes one or more openings to receive the pegs 422 extending from the actuator 414. The inner body 450 is coupled with the side pieces 403 of the outer body 460 at axis (C). The outer body 460 and the inner body 450 define an arm configured to rotate about the mount 420 at axis (B).

The outer body 460 functions to rotate the elevator cable management system 400 into a retracted position responsive to movement by an elevator car 10 upwards through an elevator shaft. The outer body 460 additionally functions to rotate the elevator cable management system into an extended position responsive to the elevator car 10 moving downwards through the elevator shaft. In some examples, the spring 424 is compressed as the elevator car 10 pushes the inner body 450 upwards. Once the elevator car 10 passes the elevator cable management system 400, the spring 424 is released for the compressed position, thereby pushing the inner body 450 away from the top plate 416.

The elevator cable management system 400 defines three axes of rotation (A), (B), and (C). By way of example, the inner body 150 is pushed upwards by the elevator 10, pivoting about axis (C) responsive to coming into contact with the top surface of the elevator 10. In this way, the distance between the top plate 452 of the inner body and the top plate 416 (height (H)) is closed or reduced. As the inner body 450 is pushed upwards, the actuator 414 pushes the arms 411, 413 upward such that they rotate about axis (A) to open the gate 410. As the elevator car 10 continues to push the elevator cable management system 400 upward, the outer body rotates about axis (B) until the elevator cable management system 400 defines a retracted position (e.g., aside the elevator car 10, vertical, substantially vertical, etc.).

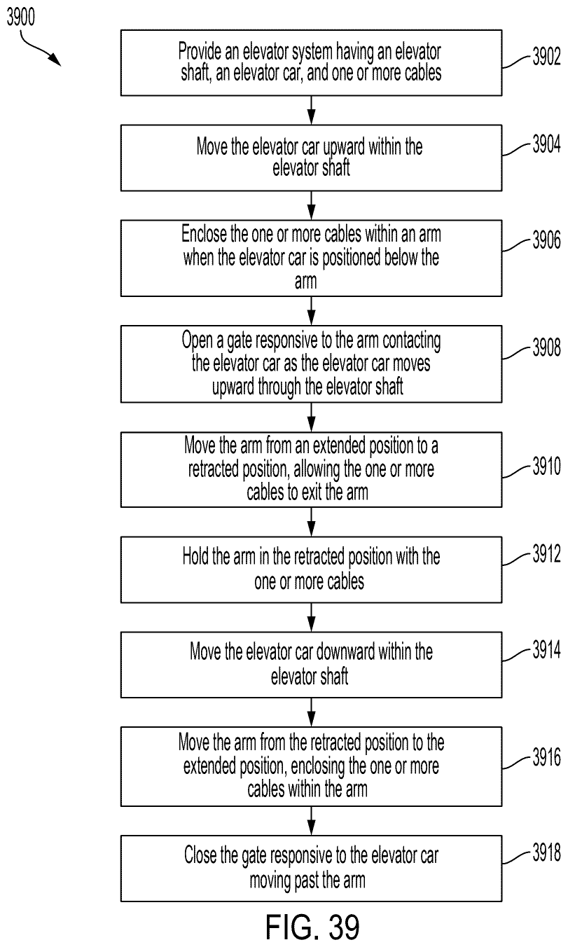

Referring to FIG. 39, a flow chart of a method 3900 for operating an elevator system is shown, according to an exemplary embodiment. The elevator system includes an elevator shaft, an elevator car, and one or more cables (Step 3902). At step 3904, the elevator car is moved upward within the elevator shaft along the one or more cables. The elevator car is moved upward and downward within the elevator shaft by a hoisting mechanism operatively coupled with the one or more cables.

At step 3906, the one or more cables are partially enclosed by an arm (e.g., the arm defined by the elevator cable management system 100, 200, 300, or 400). As described with respect to the elevator cable management systems 100, 200, and 400, the arm includes side pieces and a top plate. The side pieces extend past the top plate to define a U-shaped opening, through which the cables are disposed. Alternatively, the arm includes prongs that define a U-shaped or V-shaped opening through which the cables are disposed, as described with respect to the elevator cable management system 300. A gate is disposed across the U-shaped opening defined by the arm. When closed, the arm and gate enclose the cables such that the movement of the cables is limited.

At step 3908, the elevator car makes contact with the arm as the elevator moves upward through the elevator shaft. Responsive to the elevator car making contact with the arm, a gate (e.g., the gate 110, 210, or 410, or the retaining mechanism 310) is opened.

At step 3910, the arm moves from an extended position to a retracted position, while the gate is open. The extended position, for example, is defined by the arm being positioned substantially horizontally, whereas the retracted position, for example, is defined by the arm being positioned substantially vertically. In this step, the elevator car moves the arm to rotate upward, towards a wall of the elevator shaft, as the elevator car moves upward through the elevator shaft. The cables exit the arm through the open gate when the arm moves from the extended position to the retracted position.

At step 3912, the arm is held in the retracted position. The cables pass through the top of the elevator car and exit through the side of the elevator car. In this way, the arm encloses the portion of the cables that extend from, and pass through, the top of the elevator car. In some examples, the arm is held in the retracted position by the portion of the cables that exit through and extend from the side of the elevator car. In other examples, the arm is held in a retracted position by an internal mechanism (e.g., torsion springs, hinges, detent mechanisms, cam locks, pin locks, etc.).

At step 3914, the elevator car moves downward within the elevator shaft. At step 3916, as the elevator car passes the arm while traveling in the downward direction, the arm moves from the retracted position to the extended position. In this example, the arm remains in the retracted position by resting against the cables extending from the side of the elevator car and by resting against the side of the elevator car once the cables have passed. The arm begins to rotate downwards from the retracted position to the extended position as the top of the elevator car passes the arm. The arm reaches the extended position once the elevator car has moved fully past the arm. Once in the extended position, the side pieces and top plate of the arm enclose the cables.

At step 3918, the gate closes responsive to the elevator car moving past the arm. In this way, the gates fully enclose the cables extending from the top of the elevator car. Thus, the cables may occasionally come into contact with the arm or the gate when swaying but are prevented from coming into contact with other components of the elevator system, such as the elevator shaft, platforms, gallery, or other cables, among other components.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, or elements, or acts of the systems and methods herein referred to in the singular may also embrace implementations including a plurality of these elements, and any references in plural to any implementation, or element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive “or” to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, or orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of top and bottom, upper and lower, front and back, or left and right may be reversed or interchangeable. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical, or other positioning or orientation descriptions include variations within +/−10% or +/−10 degrees of pure vertical, parallel, or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An elevator cable management system comprising:
a first body; and
a gate hingedly coupled with the first body, the gate configured to retain one or more cables that extend from an elevator car when in a closed position;
wherein the gate is configured to transition from the closed position to an open position responsive to the elevator car making contact with the elevator cable management system; and
wherein the first body is configured to move away from the one or more cables to a position aside the elevator car responsive to the elevator car moving relative to the elevator cable management system.

2. The elevator cable management system of claim 1, further comprising:
a second body coupled with the first body; and
an actuator coupled with the second body and configured to engage with the gate, such that the actuator moves the gate from the closed position to the open position;
wherein the second body is configured to be pushed upwards by the elevator car such that the actuator pushes the gate to the open position.

3. The elevator cable management system of claim 2, wherein the second body is disposed inside of the first body.

4. The elevator cable management system of claim 2, wherein the second body comprises a first leg pivotably coupled with the first body, a second leg pivotably coupled with the first body, and a top plate extending between the first leg and the second leg.

5. The elevator cable management system of claim 4, wherein a first roller is coupled with the first leg, and a second roller is coupled with the second leg, the first roller and the second roller configured to engage with a surface of the elevator car.

6. The elevator cable management system of claim 4, wherein the actuator extends from an end of at least one of the first leg or the second leg.

7. The elevator cable management system of claim 1, wherein the first body is configured to rest on the one or more cables such that the elevator cable management system is held in a retracted position by the one or more cables after the elevator car passes the elevator cable management system.

8. The elevator cable management system of claim 1, further comprising a stop configured to hold the first body in an extended position relative to the one or more cables when the elevator cable management system is in a position to retain the one or more cables.

9. The elevator cable management system of claim 1, further comprising a mount, wherein the first body is pivotably coupled with the mount such that the first body is configured to rotate about the mount responsive to the elevator car making contact with the first body.

10. The elevator cable management system of claim 1, wherein the first body comprises a first side piece, a second side piece, and a top plate extending between the first side piece and the second side piece, and
wherein the gate is hingedly coupled with an end of at least one of the first side piece or the second side piece.

11. The elevator cable management system of claim 10, wherein the gate comprises one or more arms configured to rotate about at least one of the first side piece or the second side piece of the first body.

12. The elevator cable management system of claim 10, further comprising a first roller coupled with the first side piece and a second roller coupled with the second side piece, the first roller and the second roller configured to engage with a surface of the elevator car.

13. An elevator system comprising:
an elevator car;
one or more cables that extend from the elevator car; and
an elevator cable management system comprising:
an outer body;
an inner body; and
a gate hingedly coupled with a first side of the outer body and a second side of the outer body, the gate configured to retain the one or more cables that extend from the elevator car when in a closed position;
wherein the gate is configured to transition from the closed position to an open position responsive to the elevator car making contact with the inner body; and
wherein a component of the elevator cable management system is configured to rotate away from the one or more cables to a position aside the elevator car responsive to the elevator car moving relative to the elevator cable management system.

14. The elevator system of claim 13, wherein the inner body comprises a first leg pivotably coupled with the outer body, a second leg pivotably coupled with the outer body, and a top plate extending between the first leg and the second leg.

15. The elevator system of claim 14, wherein a first roller is coupled with the first leg, and a second roller is coupled with the second leg, the first roller and the second roller configured to engage with a surface of the elevator car.

16. The elevator system of claim 13, further comprising an actuator coupled with an end of the inner body and engaged with the gate, wherein the actuator is configured to move the gate from the closed position to the open position responsive to the elevator car making contact with the inner body.

17. The elevator system of claim 13, further comprising a mount, wherein the outer body is pivotably coupled with the mount such that the outer body rotates about the mount responsive to the elevator car making contact with the inner body.

18. The elevator system of claim 13, further comprising a first roller and a second roller configured to engage with the elevator car, and wherein the outer body comprises a first side piece coupled with the first roller, a second side piece coupled with the second roller, and a top plate extending between the first side piece and the second side piece.

19. The elevator system of claim 18, wherein the gate comprises one or more arms configured to rotate about at least one of the first side piece or the second side piece of the outer body.

20. An elevator cable management system comprising:
a mount;
a first arm pivotably coupled to the mount and configured to rotate relative to the mount between an extended position and a retracted position;
a second arm pivotably coupled to the first arm and configured to rotate relative to the first arm between a disengaged position and an engaged position;
a gate configured to move between an open position and a closed position enclosing one or more cables of an elevator system within the first arm; and
a stop configured to limit rotation of the first arm and stop the first arm in the extended position;
wherein, in operation, the second arm is configured to contact an elevator car moving upward through an elevator shaft, thereby causing the second arm to rotate from the disengaged position to the engaged position;
wherein, in operation, rotation of the second arm to the engaged position opens the gate allowing the one or more cables to exit the first arm; and
wherein, in operation, the first arm or the second arm is configured to contact the elevator car moving upward through the elevator shaft, thereby causing the first arm to rotate from the extended position to the retracted position.
